(19) United States
(12) Patent Application Publication
(10) Pub. No.: US 2012/0053925 A1
(43) Pub. Date: Mar. 1, 2012

(54) Method and System for Computer Power and Resource Consumption Modeling

(76) Inventors: Steven Geffin, N. Miami Beach, FL (US); Andres Folleco, Dania Beach, FL (US); Michael Ransom, Parkland, FL (US)

(21) Appl. No.: 13/220,613

(22) Filed: Aug. 29, 2011

Related U.S. Application Data
(60) Provisional application No. 61/378,928, filed on Aug. 31, 2010.

(51) Int. Cl. G06F 13/10

(52) U.S. Cl. 703/21

(57) ABSTRACT

Methods and systems are provided to precisely model the power consumption of both monolithic (physical) and virtual computing devices in near-real-time or real-time, allowing for precise prediction and classification of power and/or resource use and detection of anomalous power and/or resource utilization solely based on a system's operational workloads.

### RELATED APPLICATION

This application claims benefit to U.S. Provisional Patent Application Ser. No. 61/378,928 filed Aug. 31, 2010, entitled “Method and System for Power Capacity Planning” which is incorporated by reference herein.

### FIELD OF THE INVENTION

This generally relates to computing and information technology (“IT”) power consumption and more particularly to devices for the prediction and classification of power and/or resource utilization in computer systems.

### BACKGROUND

Modern data center planning and operations require comprehensive addressing of energy management throughout the data center environment, including scenarios involving multiple data centers. In the modern IT environment, it is generally no longer adequate to only conduct performance management of IT equipment; detailed monitoring and measurement of data center performance, utilization, and energy consumption to support detailed cost control, high level IT security, and “greener” environments are now typical business requirements. Modern data centers and/or other computing systems or processes create high resource demands, and the associated costs of these resources necessitate high level capacity planning.

Conventional capacity planning power consumption prediction tools include “look up table” tools requiring the user to enter the system configuration parameters before the tool retrieves the corresponding predictive power consumption. A majority of these tools do not consider current and/or newer systems' respective operational workloads as input. Rather, these tools' typical inputs are from static or semi-static measurements from monitoring tools connected to existing systems (hardware) only. Additionally, conventional servers often host multiple applications, which in the IT environment are likely to come from different business units as modern companies find it prudent to spread applications from different business units throughout their hardware to limit the impact of a hardware failure on individual business units.

Additionally, modern data centers and/or other computing systems or processes often utilize virtualization, or “cloud computing”—internet based computing whereby shared resources, software, and other information are provided to computers and other devices on demand. Cloud computing is a byproduct and consequence of the advancing ease of access to remote computing sites provided by the internet, and has become increasingly popular because it allows high level use of the server by customers without the need for them to have expertise in, or control over the technology infrastructure in the cloud that supports their data centers and/or other computing systems or processes. Many cloud computing offerings employ the utility computing billing model, which is analogous to the consumption based billing of traditional utility services such as electricity. Workload based energy and resource utilization management is typically more significant in cloud computing environments because the actual system equipment cannot be directly managed, monitored or metered.

Modern computing has continually shifted workloads away from physical computers and onto virtual machines. Virtual machines are separated into two major categories based on their use and degree of correspondence to any real machine. A system virtual machine provides a complete system platform which supports the execution of a complete operating system (OS). In contrast, a process virtual machine is typically designed to run a single program, meaning that it supports a single process. Conventional computing offers no near-real-time nor real-time method of monitoring power consumption or power usage for such devices, which are not and/or cannot be connected to a metered power source. Additionally, a busy virtual machine can easily reach the memory limit of the physical machine it is running on, requiring the virtual machine administrator to shift the virtual machine to another target platform whose memory is less taxed in a process called “Vmotion.” Vmotion of one or more virtual machines to a target platform located in a distinct heating, ventilating, and air conditioning (“HVAC”) zone can create a “hot spot” in that HVAC zone, causing the HVAC system to expend a large amount of energy to re-establish the steady state in that zone. Overall, the current state of power consumption prediction technology contains no approach allowing for the management and optimization of the assignment of virtual machines to host platforms. Moreover, these methods do not take into consideration current or newer systems' operational workloads as input data.

Finally, the rise of modern computing has seen a corresponding rise in computer crime and other anomalous, clandestine, and unauthorized uses of system capacity. Conventional anomaly detection methods and systems distinguish anomalous use through network traffic and/or system logs. However, the classification of such attacks and other anomalous uses becomes more difficult as the sophistication of the attacker rises. For instance, sophisticated malware can launch an attack that avoids normal detection methods and only causes a system or process's power and/or resource usage to briefly increase, a blip that is conventionally indiscernible by current detection methods. Further, such malware can hide inside a system's trusted processes, e.g., OS level software tasks, which can include the on-board monitoring facilities themselves, making the detection of such anomalous events even more difficult or nearly impossible prior to system failure.

### SUMMARY

In accordance with methods and systems consistent with the present invention, a method in a data processing system is provided for predicting future power consumption in computing systems. The method comprises receiving an indication of one or more computing devices to predict power for, and receiving one or more input parameters associated with the one or more computing devices. It further comprises automatically generating a prediction of the power consumption of the one or more computing devices over a future time interval, and transmitting the generated prediction.

In one implementation, a data processing system for predicting future power consumption in computing systems is provided. The data processing system comprises a memory comprising instructions to cause a processor to receive an indication of one or more computing devices to predict power for, and receive one or more input parameters associated with the one or more computing devices. The instructions further cause the processor to automatically generate a prediction of the power consumption of the one or more computing devices over a future time interval, and transmitting the generated prediction. The data processing further comprises a processor configured to execute the instructions in the memory.

In another implementation, a method in a data processing system is provided for determining current power consumption and predicting future power consumption in computing systems. The method comprises receiving an indication of one or more computing devices to predict power for, and receiving one or more input parameters associated with the one or more computing devices. The method further comprises automatically generating one of: 1) a current status of the power consumption of the one or more computing devices, and 2) a prediction of the power consumption of the one or more computing devices over a future time interval, and transmitting the one of: (1) the current status of the power consumption and (2) the generated prediction.

### BRIEF DESCRIPTION OF THE DRAWINGS

FIG. 1 illustrates a computer system consistent with methods and systems in accordance with the present invention.

FIG. 2 illustrates an exemplary system window view of the user interface for the monolithic server(s) power capacity planner (PCP) consistent with methods and systems in accordance with the present invention.

FIG. 3 illustrates steps in a method for measuring and/or modeling resource utilization based on non-virtualized servers in accordance with methods and systems consistent with the present invention.

FIG. 4 illustrates a further exemplary system window view of a unique, time-based, prediction of power usage based on a workload profile definition consistent with methods and systems in accordance with the present invention.

FIG. 5 illustrates steps in a further method for measuring and/or modeling resource utilization based on work profiles previously defined, in accordance with methods and systems consistent with the present invention.

FIG. 6 illustrates a further exemplary system window view of the user interface for the Virtual Machine(s) power capacity planner consistent with methods and systems in accordance with the present invention.

FIG. 7 illustrates steps in a further method for measuring and/or modeling resource utilization based on virtualized and/or non-virtualized servers (monolithic) in accordance with methods and systems consistent with the present invention.

FIG. 8 illustrates a further exemplary system window view of an exemplary Model Creation user interface consistent with methods and systems in accordance with the present invention.

FIG. 9 illustrates steps in a method for creating resource utilization prediction models in accordance with methods and systems consistent with the present invention.

FIG. 10 illustrates a further exemplary system window view of a Synthetic Meter consistent with methods and systems in accordance with the present invention.

FIG. 11 illustrates steps in a method for measuring resource utilization based on the Synthetic Meter's input definition in accordance with methods and systems consistent with the present invention.

FIG. 12 illustrates a further exemplary system window view of an exemplary Power Estimator consistent with methods and systems in accordance with the present invention.

FIG. 13 illustrates steps in a method for estimating server power consumption from resource utilization data based on operational workloads previously obtained in accordance with methods and systems consistent with the present invention.

FIG. 14 illustrates a further exemplary system window view of an exemplary Anomaly Detector consistent with methods and systems in accordance with the present invention.

FIG. 15 illustrates steps in a method for detecting anomalous computing resource utilization in accordance with methods and systems consistent with the present invention.

FIG. 16 illustrates steps in a method for generating resource utilization prediction models in accordance with the present invention.

FIG. 17 illustrates steps in a method for calculating a single resource utilization prediction from the various individual predictions made by a prediction model in accordance with methods and systems consistent with the present invention.

FIG. 18 illustrates steps in an exemplary method for synthetically generating supervised training data (used to generate machine learning models) based on a range of workloads where independent (CPU and Memory utilization as percentages) and dependent (the power draw in watts respective to each set of values from CPU and Memory usage) variable values are generated in accordance with methods and systems consistent with the present invention.

### DETAILED DESCRIPTION

Methods and systems in accordance with the present invention provide accurate power and/or resource consumption predictions and classifications in monolithic physical servers, facility equipment, individual virtual machines, groups of virtual machines running on a common physical host, and individual processes and applications running on such machines. Methods and systems consistent with the present invention apply domain agnostic data mining and machine learning predictive and classification modeling to quantitatively characterize power consumption and resource utilization characteristics of data centers and other associated computing and infrastructure systems and/or processes.

Further, workload-based energy and resource utilization management measurement, prediction, and classification enables organizations to place value on every kilowatt (“kW”) of energy used in their data centers as well as accurately charge back operational costs to their customers. Methods and systems consistent with the present invention further enable organizations to schedule the time and place applications run based on energy cost and availability. A company with geographically diverse datacenters may be able to schedule certain applications to run on datacenters located in areas where it is nighttime, potentially saving costs because energy tariffs are typically lower at night. Further, when organizations use cloud computing, the general energy costs are apportioned. Methods and systems consistent with the present invention allow greater transparency of individual workload associated energy costs, which can be used in financial modeling and metrics. Additionally, methods and systems consistent with the present invention enable users to compare the energy efficiency of their software.

Data Mining and/or Machine Learning (the terms are used interchangeably in the field) is a scientific discipline concerned with the design and development of algorithms that allow computers to evolve behaviors based on empirical data. A focus of machine learning is to automatically learn to infer and recognize complex patterns within such data to make intelligent decisions based on such patterns and inferred knowledge. The difficulty lies in the fact that the set of all possible behaviors given all possible inputs is typically too complex to describe manually or in a semi-automated fashion. Domain agnosticism defines a characteristic of data mining and machine learning whereby the same principles and algorithms are applicable to many different types of computing or non-computing devices beyond servers, personal computers, or workstations; including such disparate devices as UPSs, networked storage processors, generators, battery backup systems, and other applicable pieces of equipment including HVAC controllers, in the data center as well as outside. This characteristic allows scalable infrastructure management (“IM”) for single and multiple data centers as well as cloud computing infrastructures. Specifically, predictive models, processes or algorithms that find and describe structural patterns in data that can help explain such data and make predictions from it, are programmatically created with the help of a machine learning library toolkit (Weka) that can forecast and classify power consumption and resource usage as a function of hardware (virtualized or non-virtualized) resource utilization. The models efficiently provide predictions for energy consumption, for example in kilowatts (“kW”); power cost, for example in total cost per predicted period); heat dissipation, for example in British Thermal Units per hour (“BTU/hr”); greenhouse gas effects, for example in pounds per year (“lbs/year”); and other pertinent forecasts and resource utilization classifications.

A Power Capacity Planner (“PCP”) is a component application that includes some of the features of a Data Center Infrastructure Management (“DCIM”) system. Data center infrastructure management comprises the control, monitoring tuning and other management functions of the equipment and resources needed and used in data centers. The PCP provides power consumption, heat dissipation, regional cost-per-unit of power, and regional greenhouse effects predictions based on potential, user input, time-varying server workloads, for both virtualized and non-virtualized servers. A workload is system (server) resource (CPU and memory) utilization required by operational business applications. A workload comprises CPU and memory resources needed by a software application to function as expected. A workload can vary based on how much work a business application(s), or any other suitable application, is currently performing. Workloads are typically measured within the system hosting the application(s). Workloads may be “synthetically” generated in order to effectively optimize prediction and classification capabilities. Predictive and classification models are effectively independent of software running on the target system(s). The power draw/footprint of the hardware, whether it is virtualized or non-virtualized, is a primary factor used to generate the predictive and classification models. Any number of servers with equal or similar power consumption footprints may be grouped and analyzed together providing the capability to consolidate or expand server quantities as needed. This also facilitates the “relocation” or “movement” of servers (typically virtualized) to other less taxed HVAC cooling zones within a data center, for example. The PCP also allows efficient, customized creation of models in real-time for those virtual or non-virtualized platforms that have not been categorized previously.

The PCP application may use of machine learning technology that enables the prediction and classification modeling of dependent variables (outputs), such as power consumed, based on data sources containing independent variables (inputs), such as resource (CPU and Memory) utilization, which may be measured as percentages.

The PCP may be web-enabled and may comprise a client front end (or web-service), in which the user inputs relevant parameters with some up-front processing taking place, and a server back end, in which most of the processing as well as the execution of the machine learning models occurs. In one implementation, the bridge between the client front end and the server back end is Java Server Pages (“JSP”), which facilitate the use of the HTTP protocol over the internet for fast and efficient distributed data sharing. The client front end may be, for example, implemented using Adobe Flex/Flash Multi-Media Optimized XML (“MXML”) and ActionScript for high quality graphics. The server back end may be implemented using Java and/or Oracle Fusion middleware to optimize portability. However, any other suitable implementation may be used.

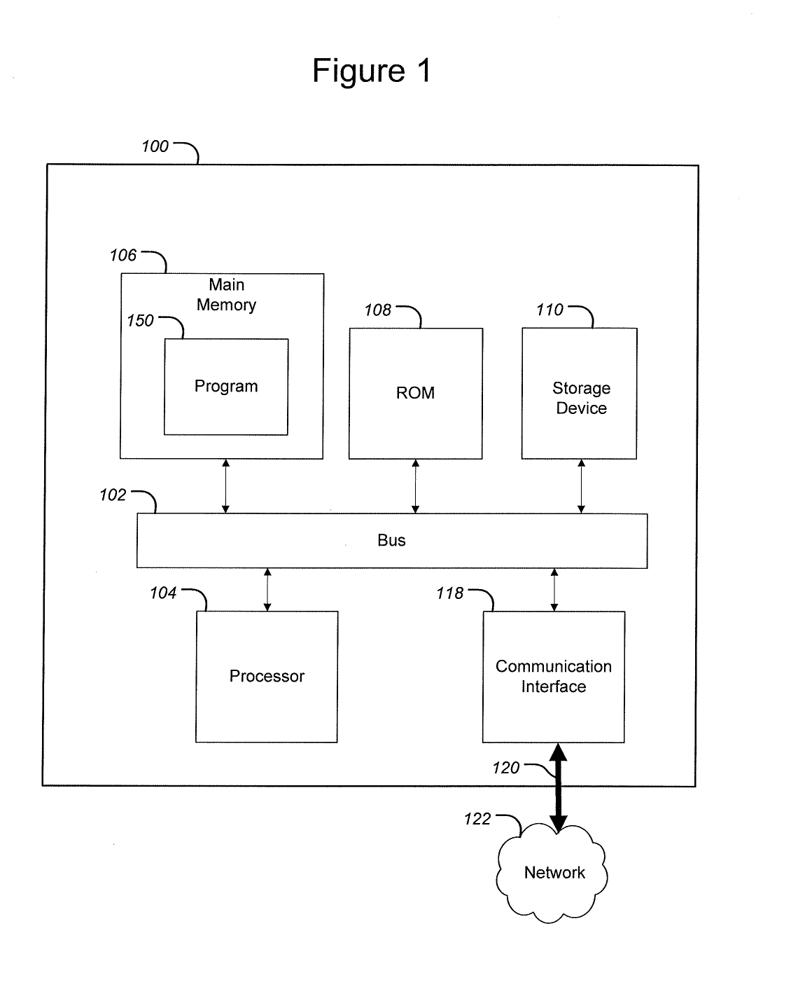

FIG. 1 illustrates an exemplary computer system 100 consistent with methods and systems in accordance with the present invention. Computer system 100 includes a bus 102 or other communication mechanism for communicating information, and a processor 104 coupled with bus 102 for processing the information. Computer 100 also includes a main memory 106, such as a random access memory (RAM) or other dynamic storage devices, coupled to bus 102 for storing information and instructions to be executed by processor 104. In addition, main memory 106 may be used for storing temporary variables or other intermediate information during execution of instructions to be executed by processor 104. Main memory 106 includes program 150 for implementing systems in accordance with methods and systems consistent with the present invention. Computer 100 further includes a read only memory (ROM) 108 or other static storage device coupled to bus 102 for storing static information and instructions for processor 104. A storage device 110, such as a magnetic disk, optical disk, or network based drives are provided and coupled to bus 102 for storing information and instructions. There may be more than one of each of these components.

According to one embodiment, processor 104 executes one or more sequences of one or more instructions contained in main memory 106. Such instructions may be read into main memory 106 from another computer-readable medium, such as storage device 110. Execution of the sequences of instructions in main memory 106 causes processor 104 to perform the process steps described herein. One or more processors in a multi-processing arrangement may also be employed to execute the sequences of instructions contained in main memory 106. In alternative embodiments, hard-wired circuitry may be used in place of or in combination with software instructions. Thus, embodiments are not limited to any specific combination of hardware circuitry and software.

Although described relative to main memory 106 and storage device 110, instructions and other aspects of methods and systems consistent with the present invention may reside on another computer-readable medium, such as a floppy disk, flexible disk, hard disk, magnetic tape, CD-ROM, magnetic, optical or physical medium, RAM, PROM, EPROM, FLASH-EPROM, any other memory chip or cartridge, or any other medium from which a computer can read, either now known or later discovered.

Computer 100 also includes a communication interface 118 coupled to bus 102. Communication interface 118 provides a two-way data communication coupling to a network link 120 that is connected to one or more network 122, such as the Internet or other computer network. Wireless links may also be implemented. Communication interface 118 may send and receive signals that carry digital data streams representing various types of information.

In one implementation, computer 100 may operate as a web server (or service) on a computer network 122 such as the Internet. Computer 100 may also represent other computers on the Internet, such as users' computers having web browsers, and the user's computers may have similar components as computer 100.

A Server Planner component of the PCP enables the prediction of power consumption, heat dissipation, regional power costs, and regional greenhouse gas effects based on potential, user defined, time-varying, sector workloads. It may use prediction models. Time-varying workload profiles allow effective and realistic prediction of power consumption and cooling requirements that fluctuate over time. These power consumption predictions may be used to plan computer usage in data centers, for example.

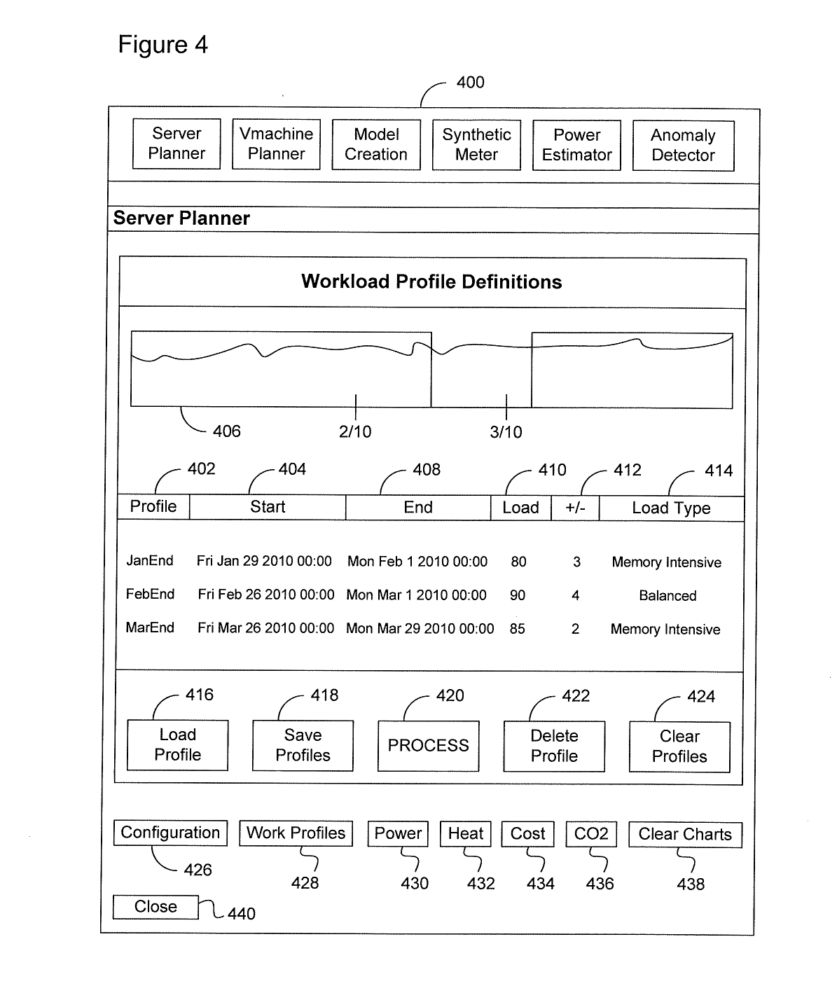

The Server Planner allows a user to estimate power consumption for any number of homogenous or heterogeneous servers that have similar power draw requirements. In one implementation, it may work for servers with dissimilar energy consumption requirements. Generally, heterogeneous servers can be grouped together if they have similar power consumption levels during significant workloads and at idle times. The Server Planner also defines work profiles, discussed further in relation to FIG. 4. Work profiles allow time-sensitive workload changes within a larger time interval. In one implementation, a work profile may be defined by the start time and end time between which a server or group of servers is modeled for power consumption. In one implementation the work profile may further be defined by the load, or power draw as a percentage of server capacity, at which the server is modeled, which load may be further defined by a margin of error, or “+/−.” Finally, in one implementation, a work profile may further be defined by the relative power consumption of the independent variables (CPU and memory power consumption), for example by specifying a memory intensive, CPU intensive, or balanced workload. A work profile is a computerized description of resource utilization (in terms of CPU and memory usage) defined over a period of time. For example, business day workload requirements are different than weekend or holiday workloads and therefore the energy consumption of the server(s) can vary significantly in some cases. Further, it is possible to define a work profile that changes workloads at specific times or intervals, for example only during weekends and/or holidays, or within the first quarter of the year only.

The Server Planner also displays the outcome of different potential scenarios and may allow the “stacking” of plotted/graphed scenarios, for example, a certain number and type of server having a certain power draw at the particular time intervals, on the same charts. It is possible to compare the power, heat, cost, and greenhouse effects produced by different potential scenarios, defined by work profiles for example, graphically and statistically within the same individual charts. A scenario may include, for example, comparing 10 racks of 50 Dell PE2900 servers with an average power draw of about 270 kW versus 2 racks of 80 Dell PE2900 servers with an average power draw of about 90 kW.

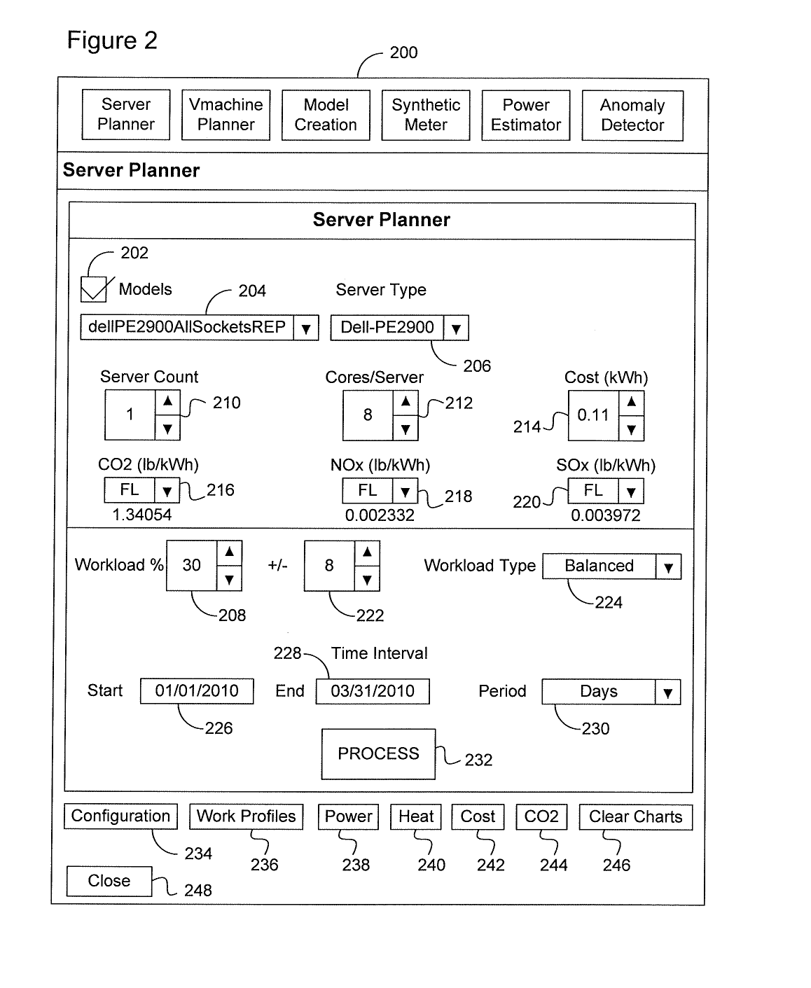

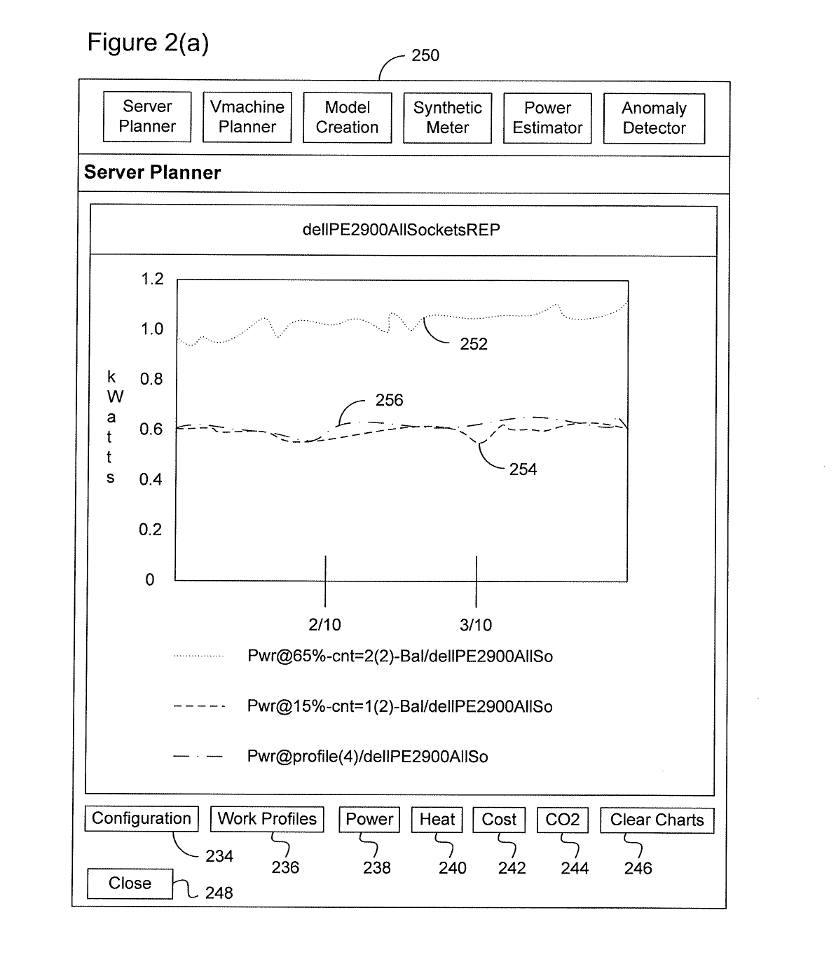

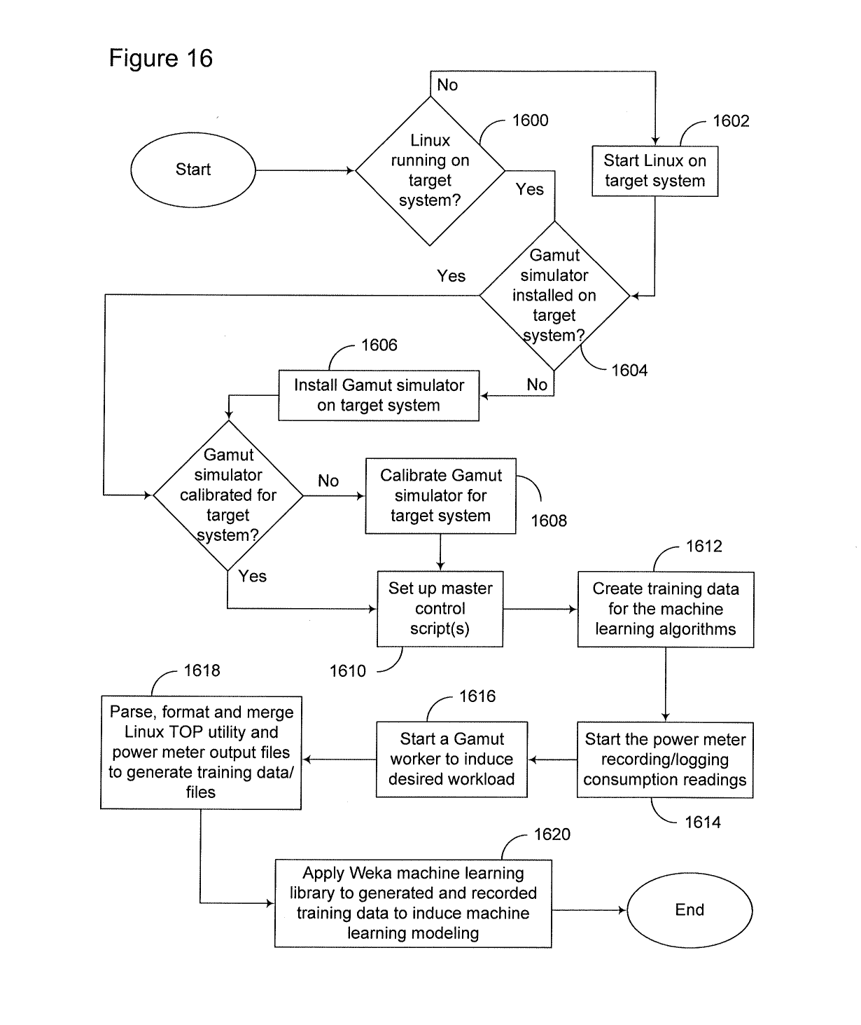

FIG. 2 illustrates one implementation of an exemplary Page View 200 corresponding to a Server Planner implementation consistent with the present invention. When Checkbox 202 is highlighted, for example by clicking on it, models defined by the user may be displayed in the Model Selection Dropdown Menu 204. The user may then select the model used in the session from Model Selection Dropdown Menu 204. In one implementation, model names suffixed with “REP” may be used for predictions. The suffix “REP” on the model name indicates that the model has already been created and is ready for use. “REP” stands for REPTree, which is the machine learning algorithm from the Weka library toolkit used to implement the model. In that implementation, other models are created using the Model Generation implementation of the PCP, described below in relation to FIG. 16. In another implementation, user defined models supersede any server type selected from Server Type Selection Dropdown Menu 206 in the same session. The selections available in Server Type Dropdown Menu 206 correspond to models for hardware platforms profiled and modeled previously. In one implementation, there may be multiple models predefined for each server type previously characterized. In another implementation, the model most closely matching the workload percentage, or power draw as a percentage of server capacity, entered in Workload % 208 dictates the power estimate. Server Count 210 represents the number of servers modeled. In one implementation, the default value of this field is 1. The value may be changed, for example, to model a rack of servers comprising multiple servers of the same type. It is also possible to consolidate the number of servers to be modeled. For example, instead of modeling 80 servers running at 35% workloads, the user may instead model only 50 servers running at 70% workloads. Cores/Server 212 may help define the model selected for a defined server type by specifying how many total cores to use in a server. In one implementation, the default value is 8. Cost 214 represents the regional cost of power for a user. In one implementation, cost is measured in dollars per kW hour (“kWh”). In another implementation, the default value is the average cost of power in the United States, e.g., $0.11/kWh. CO2 Dropdown Menu 216, NOx Dropdown Menu 218, and SOx Dropdown Menu 220 display the annual emission rates for carbon dioxide, nitrous monoxide and the various nitrous polyoxides, and sulfur monoxide and the various sulfur polyoxides; in the state selected by the user from the respective dropdown menus, with the respective values shown below the respective dropdown menus. In one implementation, emissions are measured in lbs/kWh. In another implementation, the source of this data is the eGRIDweb Version-2007.1.1.

Workload % 208 is the workload defined for the server chosen. In one implementation, workload may be defined as the percentage of CPU and memory being utilized by the server's business application(s). +/−222 represents a user defined acceptable level of variance in the workload percentage entered. Workload Type 224 defines the distribution of the chosen workload between CPU utilization and memory utilization. For example, if a user enters a Workload % of 30% and selects a “balanced” workload type, which is defined as nearly equal CPU and Memory utilization, the systems creates a model based on similar CPU utilization and memory utilization, in this case about 15% for each. Other potential workload types include, but are not limited to, “CPU intensive” or “Memory intensive”. In Start 226 the user enters the starting date of the analysis. In End 228, the user enters the ending date of the analysis. In Time Interval Period Dropdown Menu 230, the user may enter the unit of time of the modeled time interval. For example, the menu options may include hours, days, weeks, months, years, or any other unit of time.

Once the user enters the parameters, the user may click PROCESS 232 to initiate the prediction process based on input parameters. In one implementation, the PCP opens the power prediction chart automatically upon conclusion of model processing. FIG. 2(a) illustrates one implementation of an exemplary Page View 250 corresponding to this power prediction chart. Line 252, Line 254, and Line 256 represent the predicted values of power usage for the defined work profiles. In one implementation, mousing over Line 252, Line 254, or Line 256 causes the system to display statistics for the data point moused over as well as for the entire line. For example, the system may display the work profile plotted, the value of the point moused over, and the mean, high, and low values measured for that work profile.

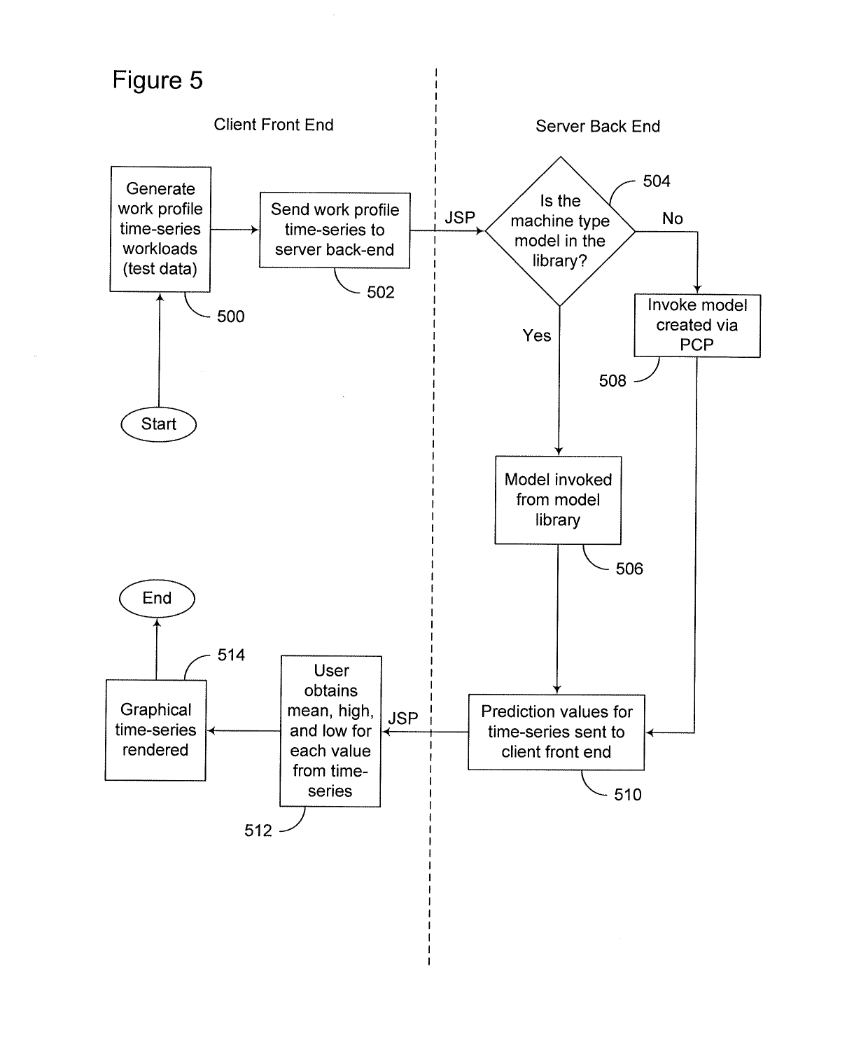

Clicking Configuration 234 opens Page View 200, the initial input parameter definition screen of the Server Planner implementation, which allows the user to enter and select the values needed to generate power predictions. Clicking Work Profiles 236 allows the definition of specific work profiles that require different workloads within a given time interval or sub-interval, as discussed below in relation to FIGS. 4 and 5. This implementation is useful if, for example, a given server rack is expected to undergo periodic changes in usage over the course of the desired time interval to be modeled. Clicking Power 238 displays a chart containing power usage estimates for the entered parameters. In one implementation, power is measured in kW. Clicking Heat 240 displays a chart containing dissipated heat estimates for the entered parameters. In one implementation, heat dissipated is measured in BTU. Clicking Cost 242 displays the chart containing cost estimates for the entered parameters. In one implementation, this is measured in U.S. dollars. Clicking CO2 244 displays a chart containing the regional CO2, SOx, and NOx output emission rate estimates for the entered parameters. In one implementation, these are measured in lbs/year. In another implementation the regions defined may be U.S. states. In one implementation the user may zoom-in on a specific data point in any of the aforementioned charts, opened by clicking Power 238, Heat 240, Cost 242, or CO2 244, by clicking on the desired point within the given chart. Clicking Clear Charts 246 closes the charts currently displayed and displays the configuration screen, Page View 200. Clicking Close 248 closes the Server Planner screen.

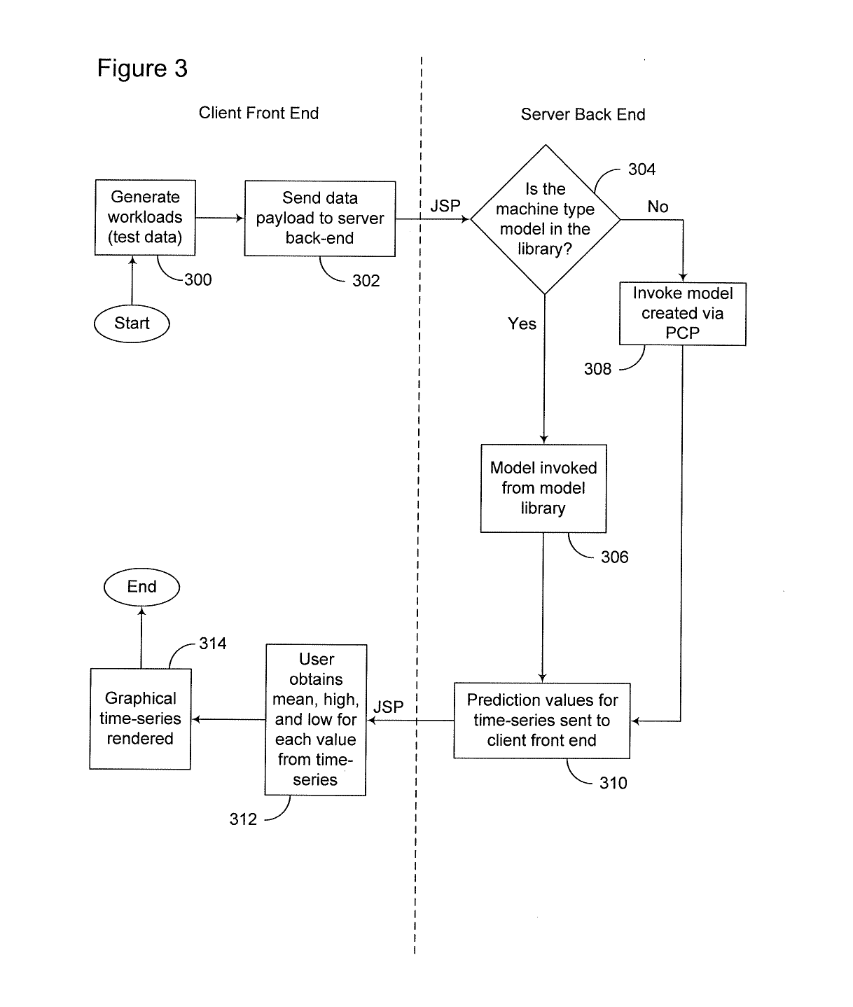

FIG. 3 illustrates steps in an exemplary method of using the Server Planner implementation consistent with the present invention, which allows the definition of a workload scenario over a time interval. First, the user generates time-series workload, a workload applied over a period of time. Workloads are entered by the user as a percentage, of CPU and memory utilization. Internally, CPU and Memory utilization are synthetically generated for the entire time interval entered by the user by entering the desired workload magnitude, duration, and workload type, for example, CPU Intensive, Memory Intensive, or Balanced to be modeled (step 300). Next, the user sends the data payload, for example time-series (workloads over a period of time), machine model, machine type and CPU core count, via the HTTP protocol for example, to the server back end (step 302). The data payload is sent from the client front end to the server back end, and on the server back end the software determines if the model library, which stores models, contains a model previously generated for the entered machine type (step 304). If the library does contain such a model, that model may be invoked (step 306). Models are created based on CPU core count and small workload increments, for example, 5% or 10%.

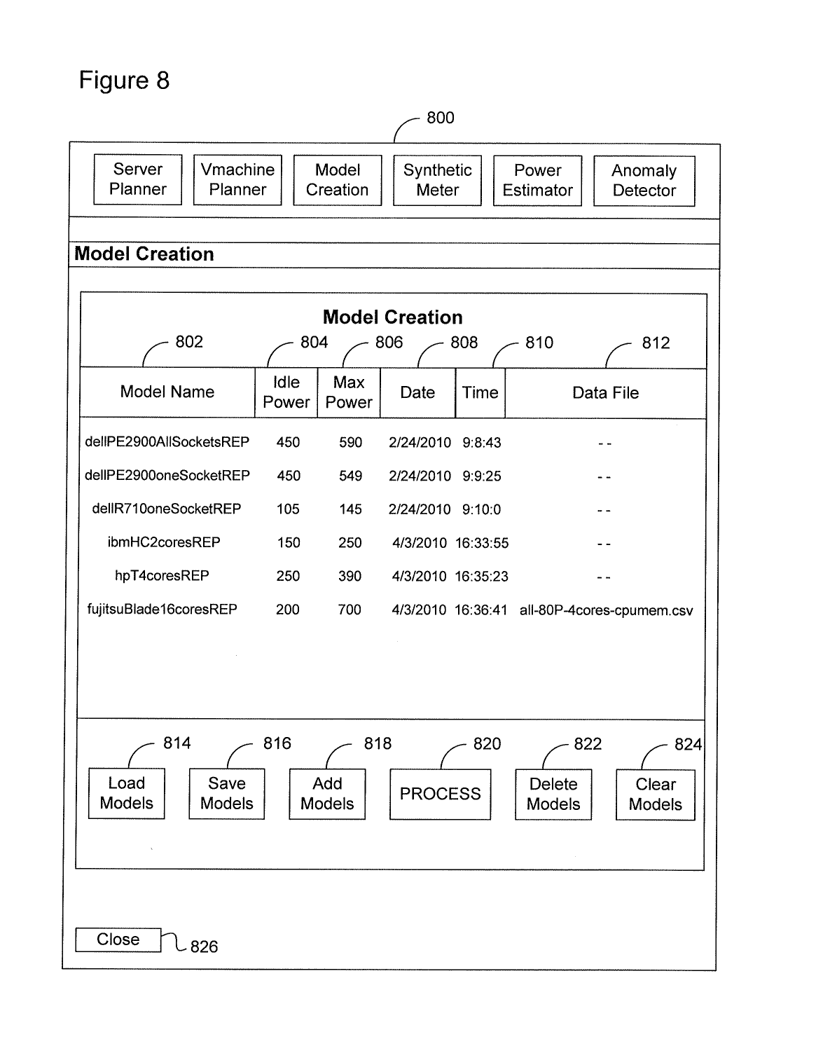

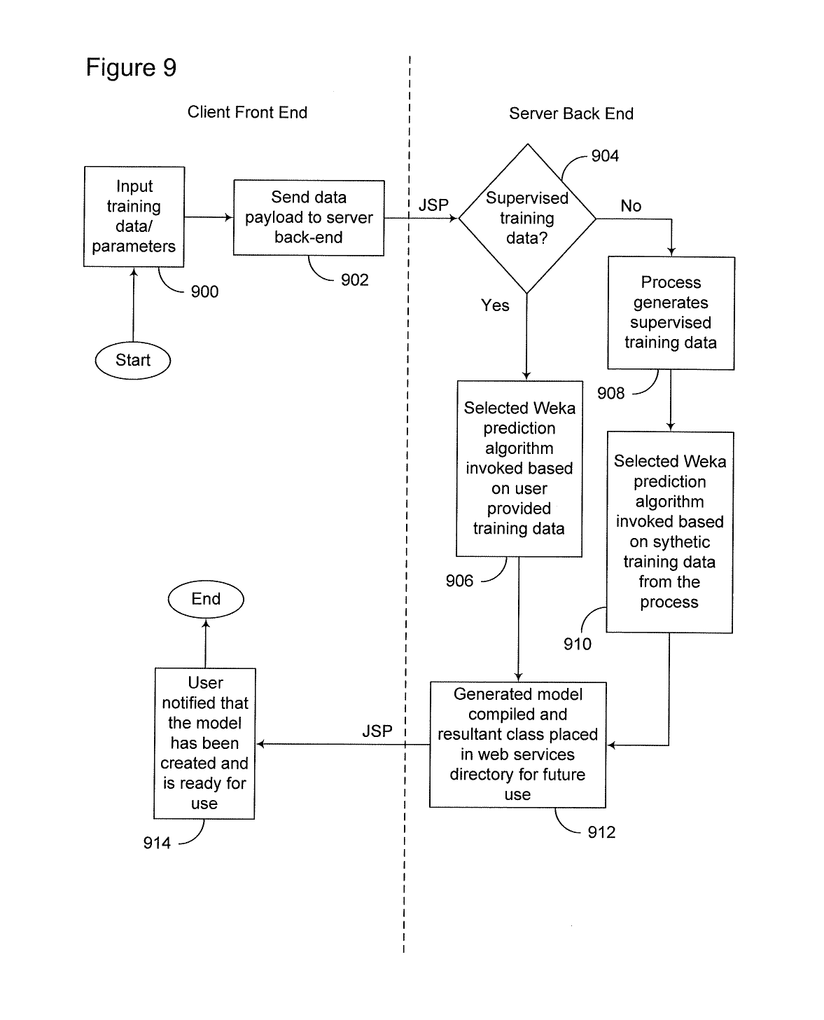

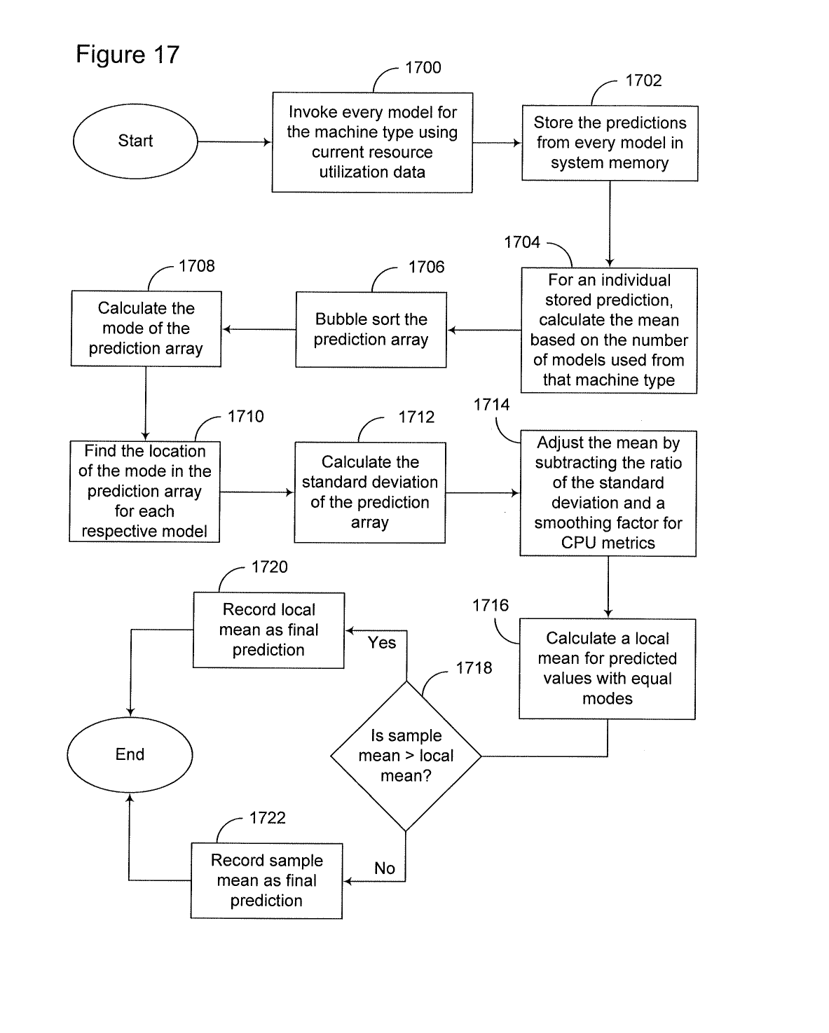

A process, described in further detail below in relation to FIG. 17, statistically derives a predicted value from the ensemble of the model's predictions for each data point. However, if in step 304 the software determines that the model library does not contain a model previously generated for the entered machine type, it may invoke a model created via PCP's Model Creation feature (step 308). Model creation is described in further detail below in relation to FIGS. 8 and 9. Additionally, PCP model creation (step 308) may supersede model invocation from the model library (step 306) when the machine training data, for example, the resource utilization independent variables (CPU and Memory) used as inputs into the predictive models, can be synthetically generated. PCP models may handle a wide variety of workloads. After an appropriate model is invoked or created, the model generates prediction values, for example, power consumption in kW for each CPU as well as Memory utilization values, for the data entered. A multitude of time-series, for example 10, may be stochastically generated for statistical significance, and the prediction values for the time-series are then sent back to the client front end (step 310). The client front end calculates the mean, high, and low values from each value of each of the multiple time-series (step 312). In one implementation, this representation may be graphical. In other implementations, the mean, high, and low prediction values are calculated for each value from the multiple time-series (10 versions of the initially generated time-series) and are also displayed via the smart-data tip feature of the line plot, wherein the graphing tool provides the ability to display in a small pop-up window any additional information associated with a specific data point of the time series graphed. In other implementations, the server count may be used to adjust the magnitude of the time series points. Finally, graphical time-series may be rendered (step 314). In one implementation, zooming capabilities and smart data-tips for each time-series point may be instantly available on cursor positioning. In other implementations, various scenarios and time-series may be “stacked” on the same chart.

The user may also perform the “Work Profiles” function of the PCP within the Server Planner. Work Profiles allows the definition of different and time changing workloads from those defined for an entire time interval. It allows the definition of specific use cases, for example a case when special workloads for each weekend of a given month are needed. The Work Profiles feature may be activated once a potential scenario has been processed. In one implementation, after such processing, the PCP automatically navigates to the Power screen, the screen that shows the power consumption over time. At this point and after analysis of the charts, the user can activate Work Profiles in order to define any special workload requirements within the given scenario's time interval, such as the ability to define workloads over specific period(s) of time within the scenario's full time interval defined previously.

FIG. 4 illustrates one implementation of an exemplary Page View 400 corresponding to the Work Profiles function of the Server Planner implementation consistent with the present invention. Profile 402 allows the naming of a specific work profile. Naming may be useful later in referencing and possibly reusing a work profile. Start 404 allows the entry of a specific time within the entire time interval at which the work profile begins. In one implementation, this field may be graphically defined by selecting the start point from Scrolling Bar 406, which may use time units from the given time interval. End 408 allows the entry of a specific date within the entire time interval at which the work profile ends. In one implementation, this field may be graphically defined by selecting the end point from Scrolling Bar 406. Load 410 defines the workload in effect during the current work profile. +/−412 defines the variability of the defined workload for the current work profile. Load Type 414 allows the definition of the load type, for example, Balanced, CPU Intensive, or Memory Intensive, for the current work profile.

Clicking Load Profile 416 loads the profiles defined by the user. In one implementation, a user may re-use a profile if it fits properly with the new time interval defined, for example, the dates could be out of range, e.g., the work profile was defined for January 2010, but the current scenario time interval is for the 3^{rd} quarter of 2010. Clicking Save Profiles 418 saves the currently defined profiles into the work profile definition XML file. Clicking PROCESS 420 applies the current displayed profiles to the previously defined and submitted scenario. In one implementation, the system updates the charts with the requirements of the work profiles applied by clicking PROCESS 420. Clicking Delete Profile 422 removes the selected profile from the system. Clicking Clear Profiles 424 closes all profiles currently displayed by the system.

Clicking Configuration 426 opens Page View 400, the initial parameter definition screen of the Work Profiles function of the Server Planner implementation. Clicking Work Profiles 428 allows the definition of further specific work profiles that require different workloads within a given time interval, as currently discussed and further discussed below in relation to FIG. 5. This implementation is useful if, for example, a given server rack is expected to undergo periodic changes in usage over the course of the desired time interval to be modeled. Clicking Power 430 displays the chart containing power usage estimates for the entered parameters. In one implementation, power is measured in kW. Clicking Heat 432 displays the chart containing dissipated heat estimates for the entered parameters. In one implementation, heat dissipated is measured in BTU. Clicking Cost 434 displays the chart containing cost estimates for the entered parameters. In one implementation, this is measured in U.S. dollars. Clicking CO2 436 displays the chart containing the regional CO2, SOx, and NOx output emission rate estimates for the entered parameters. In one implementation, these are measured in lbs/year. In another implementation the regions defined may be U.S. states. In one implementation the user may zoom in to a specific data point in any of the aforementioned charts, opened by clicking Power 430, Heat 432, Cost 434, or CO2 436, by clicking on the desired point within the given chart. Clicking Clear Charts 438 closes all charts currently displayed and displays the configuration screen, Page View 400. Clicking Close 440 closes the Work Profiles screen.

FIG. 5 illustrates steps in an exemplary method of using the Work Profiles function, which provides the definition of work profiles (time varying workloads within the previously defined scenario time interval), of the Server Planner implementation consistent with the present invention. First, the user generates work profile time-series workloads by entering the desired workload magnitude, duration, and workload type for each work profile time interval to be modeled (step 500). Next, the user sends the data payload, for example independent variable values (CPU and Memory utilization) time-series, machine model, machine type, CPU core count, and specific time interval to be modeled, via HTTP protocol for example, to the server back end (step 502). The data payload is sent from the client front end to the server back end, and on the server back end the software determines if the model library, which stores models, contains a model previously generated for the entered machine type (step 504). If the library does contain such a model, that model may be invoked (step 506). Models are created based on CPU core count and small workload increments, for example 5% or 10%. A process, described in further detail below in relation to FIG. 17, statistically derives a predicted value from the ensemble of the model's predictions for each data point. However, if in step 504 the software determines that the model library does not contain a model previously generated for the entered machine type, it may be used to invoke a model created via PCP's Model Creation feature (step 508). Model creation is described in further detail below in relation to FIGS. 8 & 9. Additionally, PCP model creation (step 508) may supersede model invocation from the model library (step 506) when the machine training data can be synthetically generated. PCP models may handle a wide variety of workloads. After an appropriate model is invoked or created, the model generates prediction values for the data entered. A multitude of time-series, for example 10, may be stochastically generated for statistical significance, and the prediction values for the time-series are sent back to the client front end (step 510). The client front end then displays a statistical representation of the results for each value from each of the multiple time-series (step 512). In one implementation, this representation may be graphical. In other implementations, the mean, high, and low prediction for each value from the multiple time-series may be given. Special handling for the work profile time interval time-series may be required. In other implementations, the server count may be used to adjust the magnitude of the time series points. Finally, graphical time-series may be rendered (step 514). In one implementation, zooming capabilities and smart data-tips for each time-series point may be instantly available on cursor positioning. In other implementations, various scenarios and time-series may be “stacked” on the same chart. In still other implementations, the work profile time intervals time-series are plotted chronologically on top of any existing time-series plotted before the work profile was processed.

The VMachine Planner feature of the PCP enables the prediction of power consumption, heat dissipation, regional power costs, and regional greenhouse gas effects for virtualized or non-virtualized servers. In one implementation, it enables prediction regarding virtualized systems that can have heterogeneous and/or homogeneous characteristics including power draw footprints. Any number of these servers can be analyzed at the same time, each with specific potential, user defined workloads and for specific time periods. It is possible to obtain the total power budget of the physical underlying platform from the virtual machines defined within the VMachine Planner.

The VMachine Planner allows the prediction of power consumption of virtualized or non-virtualized servers that can have heterogeneous and/or homogenous characteristics. This feature facilitates power and cooling budget planning where servers need to be moved to other physical locations within a data center or to remote locations. The VMachine Planner has similar charting capabilities as the Server Planner. The VMachine Planner also allows the stacking of plotted or graphed scenarios on the same charts. The system graphically and statistically compares the power, heat, cost, and greenhouse effects produced from different potential scenarios within the same individual charts.

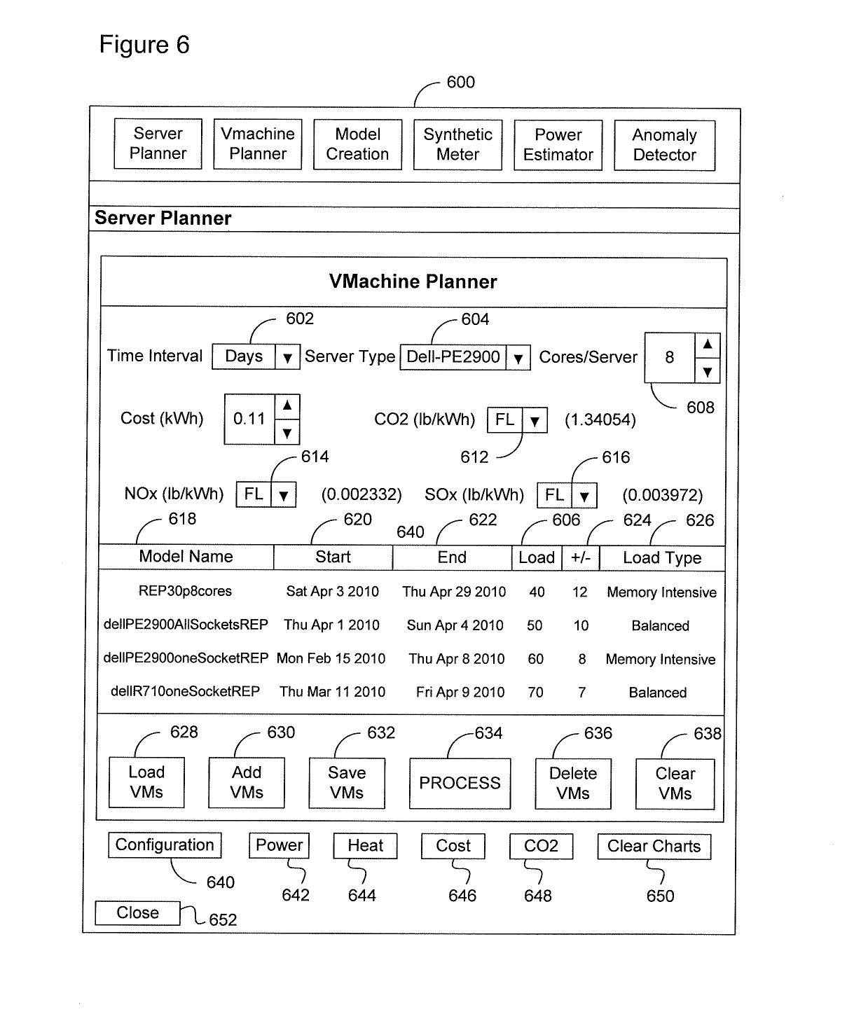

FIG. 6 illustrates one implementation of an exemplary Page View 600 corresponding to a VMachine Planner implementation consistent with the present invention. In Time Interval Period Dropdown Menu 602, the user may enter the unit of time of the modeled time interval. For example, the menu options may include hours, days, weeks, months, years, or any other unit of time. The selections available in Server Type Dropdown Menu 604 may use models for hardware platforms profiled and modeled previously. In one implementation, there may be multiple models predefined for each server type previously characterized. In another implementation, the model most closely matching the workload percentage entered in Load 606 makes the power estimate. Cores/Server 608 may help define the model selected for a defined server type by specifying how many total cores to use in a server. In one implementation, the default value is 8. Cost 610 represents the regional cost of power for a user. In one implementation, cost is measured in dollars per kWh. In another implementation, the default value is the average cost of power in the United States, e.g. $0.11/kWh. CO2 Dropdown Menu 612, NOx Dropdown Menu 614, and SOx Dropdown Menu 616 display the annual emission rates for carbon dioxide, nitrous monoxide and the various nitrous polyoxides, and sulfur monoxide and the various sulfur polyoxides; in the state selected by the user from the respective dropdown menus, with the respective values shown below the respective dropdown menus. In one implementation, emissions are measured in lbs/kWh. In another implementation, the source of this data is the eGRIDweb Version-2007.1.1.

Model Name 618 displays the models defined by the user in the entry cell selected. The user may highlight, for example by clicking, which model the user wishes the system to use for that session. In one implementation, only model names suffixed with REP may be used for predictions. In that implementation, all other models must first be created using the Model Generation implementation of the PCP, described below in relation to FIG. 16. In another implementation, user defined models supersede any server type selected from Server Type Selection Dropdown Menu 604 in the same session. Start 620 displays the starting date of the analysis under the corresponding model. End 622 displays the ending date of the analysis under the corresponding model. Load 606 displays the required workload of the corresponding model entered into the data grid. In one implementation, workload is defined as the percentage of CPU and memory being utilized to handle the defined workload. +/−624 displays the user defined acceptable level of variance in the workload percentage modeled. Load Type 626 displays the user defined the distribution of the chosen workload between CPU utilization and memory utilization. For example, if a chosen model employs a load of 30% and a balanced load type, the system will create a model based on similar CPU utilization and memory utilization, in this case about 15% for each. Other potential workload types include, but are not limited to, CPU intensive or memory intensive.

Clicking Load VMs 628 loads the servers last configured in the VMachine Planner. Clicking Add VM 630 allows the user to add an additional server to the current data grid. Clicking Save VMs 632 stores the current data grid into an XML file. Clicking PROCESS 634 initiates the prediction process for all the servers in the current data grid. Clicking Delete VM 636 deletes highlighted or selected servers within the data grid. Clicking Clear VMs 638 clears all servers and associated parameters within the current data grid.

Clicking Configuration 640 opens Page View 600, the initial parameter definition screen of the VMachine Planner implementation. Clicking Power 642 displays the chart containing power usage estimates for the entered parameters. In one implementation, power is measured in kilowatts. Clicking Heat 644 displays the chart containing dissipated heat estimates for the entered parameters. In one implementation, heat dissipated is measured in BTUs. Clicking Cost 646 displays the chart containing cost estimates for the entered parameters. In one implementation, this is measured in U.S. dollars. Clicking CO2 648 displays the chart containing the regional CO2, SOx, and NOx output emission rate estimates for the entered parameters. In one implementation, these are measured in pounds/year. In another implementation the regions defined may be U.S. states. In one implementation the user may zoom in to a specific data point in any of the aforementioned charts, opened by clicking Power 642, Heat 644, Cost 646, or CO2 648, by clicking on the desired point within the given chart. Clicking Clear Charts 650 closes all charts currently displayed and displays the configuration screen, Page View 600. Clicking Close 652 closes the VMachine Planner window.

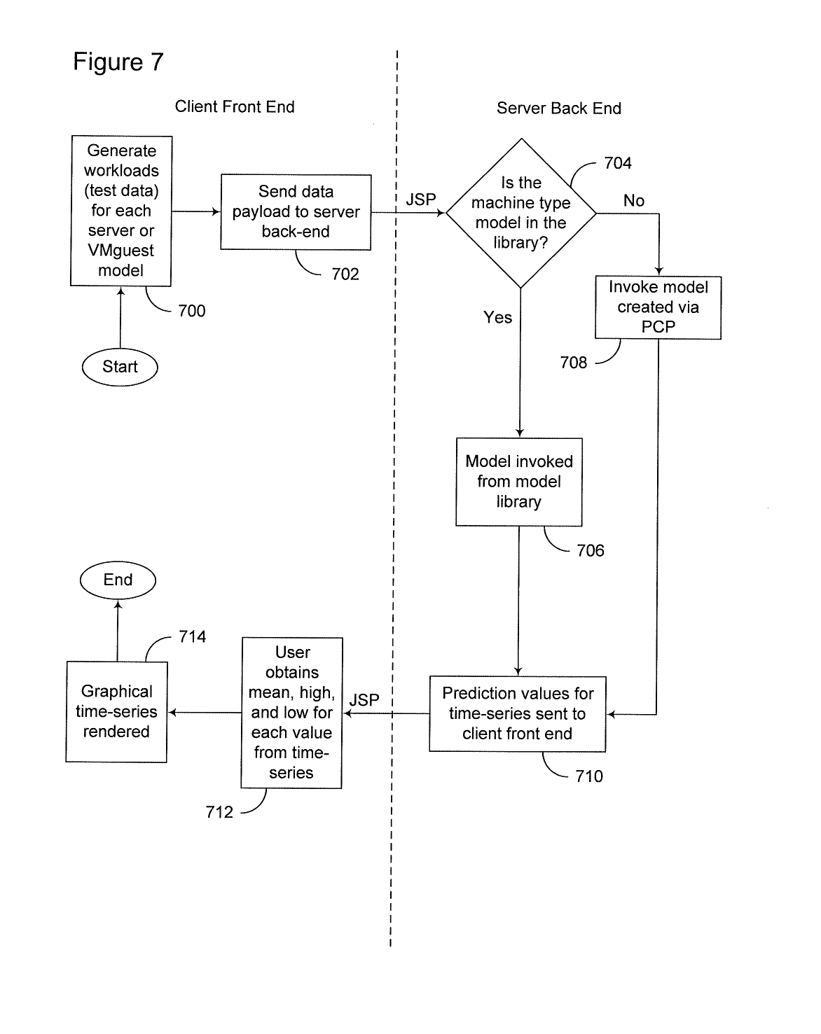

FIG. 7 illustrates steps in an exemplary method of using the VMachine Planner implementation consistent with the present invention, generally for VMachines as opposed to monolithic servers. First, the user generates time-series workloads for each server/VMguest by entering the desired model name, workload magnitude, duration, and workload type for each virtual machine to be modeled (step 700). Next, the user enters the following parameters/values which comprise the data payload and sends the data payload, for example time-series, machine model, machine type, and CPU core count, via HTTP protocol for example, to the server back end (step 702). The data payload is sent from the client front end to the server back end, and on the server back end the software determines if the model library, which stores models, contains a model previously generated for the entered machine type (step 704). If the library does contain such a model, that model may be invoked (step 706). Models are created based on CPU core count and small workload increments, for example 5% or 10%. A process, described in further detail below in relation to FIG. 17, statistically derives a predicted value from the ensemble of the model's predictions for each data point. However, if in step 704 the software determines that the model library does not contain a model previously generated for the entered machine type, it may be used to invoke a model created via PCP's Model Creation Feature (step 708). Model creation is described in further detail below in relation to FIGS. 8 & 9. Additionally, PCP model creation (step 708) may supersede model invocation from the model library (step 706) when the machine training data can be synthetically generated. PCP models may handle a wide variety of workloads. After an appropriate model is invoked or created, the model generates prediction values for the data entered. A multitude of time-series, for example 10, may be stochastically generated for statistical significance, and the prediction values for the time-series are sent back to the client front end (step 710). The client front end then displays a representation of the results for each value from each of the multiple time-series (step 712). In one implementation, this representation may be graphical. In other implementations, the mean, high, and low prediction for each value from the multiple time-series may be given. Special handling for the virtual machine model time interval time-series may be required. In other implementations, the virtual machine count may be used to adjust the magnitude of the time series points. It may be possible to use the VMachine Planner to model both virtual and non-virtual systems, for example to enable cost analysis. Finally, graphical time-series may be rendered (step 714). In one implementation, drilling/zooming capabilities and smart data-tips for each time-series point may be instantly available on cursor positioning. In other implementations, various scenarios and time-series may be “stacked” on the same chart. In still other implementations, the model time intervals time-series are plotted chronologically on top of any existing time-series plotted before the work profile was processed.

The Model Creation feature of the PCP allows a user to create a model suited for the user's own legacy or new platforms, whether virtualized or non-virtualized. This feature provides return on investment by extending the life and utility of the application.

The Model Creation feature allows the definition and creation of customized predictive models based, in one implementation, on two user input parameters: the idle power level of the fully configured system without running any workloads and the maximum workload power level for a specific server platform.

FIG. 8 illustrates one implementation of an exemplary Page View 800 corresponding to the Model Creation implementation consistent with the present invention. Model Name 802 displays the user defined name of the model to be created. In one implementation, only letters and numbers should be used in this field, and the model name is converted into a Java class which is dynamically compiled by the Java Virtual Machine's (JVM) compiler. In another implementation, if the model name is suffixed with “REP”, the model name is presumed to already exist. Idle Power 804 displays the idle power usage of the platform to be modeled. In one implementation, this is measured in watts. In another implementation, accurate measurement of idle power usage requires that the system is fully booted, all its peripheral devices are fully functional and electrically attached to the system, and any operating system (“O/S”) or master control software is fully operational as well. Additionally, this implementation requires that no workloads are present on the system when idle power usage is measured. Max Power 806 displays the maximum workload power usage of the system. In one implementation, this is measured in watts. If this measurement is unavailable, the system may use an approximation, for example, based on the manufacturer's maximum rated power draw for the given system. Date 808 displays the date when the corresponding model was defined. Time 810 displays the time of day when the corresponding model was defined. Data File 812 represents an optional entry field in which, instead of the idle power usage and maximum workload power usage of a platform, the user enters the name of a file containing the training data from the system to be modeled. Recall that training data includes the measurements of the independent variables (CPU and Memory), or resource, utilization, and the dependent variable (power consumed, for example in watts) based on active operational workloads representing a variety of load levels running on the system to be modeled. In one implementation, workloads from 5% to 90% are induced and measured on the system. The Model Creation implementation may use this input file to generate a corresponding predictive model capable of handling such training data.

Clicking Load Models 814 loads the models previously defined on that system. In one implementation, models already generated are suffixed with the characters “REP.” Clicking Save Models 816 saves the models shown in the current Model Creation screen to the XML model storage file. Clicking Add Model 818 defines a basic empty entry onto the screen, which is done for use input convenience. Clicking PROCESS 820 generates the selected model. In one implementation, the model name will be suffixed with “REP” after successful creation. Clicking Delete Model 822 deletes models highlighted in the model creation screen. Clicking Clear Models 824 clears the screen completely. Clicking Close 826 closes the Model Creation screen.

The following is an example of the comma separated values (“.CSV”) format for the Data File 812. The first row must contain a header describing the column for the CPU utilization, the Memory utilization (for example, as percentages), and the power (for example, in watts) measured:

| Cpu, | Mem, | Power |
|---|---|---|
| 24.45, | 4.149, | 470.1 |
| 48.05, | 9.671, | 498.9 |
| 98.55, | 21.181, | 570.6 |
| 98.5, | 32.648, | 570.7 |
| . . . | | |

FIG. 9 illustrates steps in an exemplary method of using the Model Creation implementation consistent with the present invention. First, the user inputs either values for the two parameters, the idle power level of the fully configured machine (with no workloads active) and the maximum power draw of that machine under a significantly high workload, or alternatively, the user can input supervised training data, which contains values for the independent (CPU and memory use) and dependent (power consumed) variables (step 900). Next, the user sends the data payload, for example model name, idle and maximum power draws for the fully configured machine, or training data, via HTTP protocol for example, to the server back end (step 902). The data payload is sent from the client front end to the server back end, and on the server back end the software determines if the input data payload consists of supervised training data (step 904). If the data payload includes supervised training data, the proper Weka machine learning library prediction algorithm, for example REPTree or M5rules (machine learning algorithms from the Weka library toolkit used to generate the power prediction models used by the PCP) may be invoked (step 906). However, if in step 904 the software determines that the data payload comprises other than supervised training data, a process, described below, synthetically generates the supervised training data (step 908), and then the proper Weka prediction algorithm is invoked based on the synthetic supervised training data created by the process (step 910). Once the new model is generated, it is compiled and the resultant class is placed in a web information services directory on the server back end for future use (step 912). The user is then notified on the client front end that the model has been created and is ready for use (step 914). In one implementation, the user may save the model under a user generated name. In another implementation, the user may also save the model's relevant features in persistent storage. Relevant features may include for example, idle and maximum power levels, CPU core count, spin factor, and million instructions per second (“MIPS”).

The Synthetic Meter enables the prediction of power consumption, heat dissipation, regional power costs and regional greenhouse gas effects for operational, metered or non-metered servers on-line in near real time. Resource utilization, such as CPU and memory usage, metrics are obtained from the operational system and input into the selected prediction models continuously, for example every second. The Synthetic Meter may use Windows WMI and Linux WMI/WBEM or the Top utility, for example, to obtain server resource utilization metrics. The Synthetic Meter may accept metrics from any data collection service over the network. Additionally, the Synthetic Meter also compares virtualized and/or non-virtualized servers by virtue of their corresponding models, enabling monitoring and comparison of power consumption and cooling requirements online within the same display chart to any servers connected to the network. The same monitoring and comparison capabilities may be available for each selected business application or task running on a particular machine, virtualized or non-virtualized. The system also can compare the power consumption predictions obtained for a business application or task between a number of machines, by virtue of their corresponding models used for each machine. This feature enhances many IT functions, for example server consolidation/relocation studies and hardware refresh projects, which involve the replacement of outdated legacy equipment with newer, more capable and efficient hardware. Power capping features at the server level as well as for specific applications or tasks may also be provided. Power capping is used to limit the amount of power consumed and/or the CPU and memory, or resource, utilization by an operational system and/or business application running on a virtualized or non-virtualized machine.

The Synthetic Meter component of the PCP allows power, heat, cost, and CO₂ emission prediction based on recently, for example near real-time, obtained CPU and memory utilization values as percentages of the total possible CPU and memory usage, for example, 50% of the total possible CPU usage from operational systems. These are the independent variables to be input into the predictive models. A user may enter a business application or task name that is running on the entered host/machine to have the metering and predictions conducted for that application or task only. The same server and/or application may be entered multiple times with different models. This allows the user to dynamically compare the power, cooling, and emission rates across different platforms for the same host and/or applications by virtue of the different selected models. Finally, the Synthetic Meter may be used to cap the power available to a host or a specific application or task, allowing users to optimize performance while limiting resource utilization and/or cost.

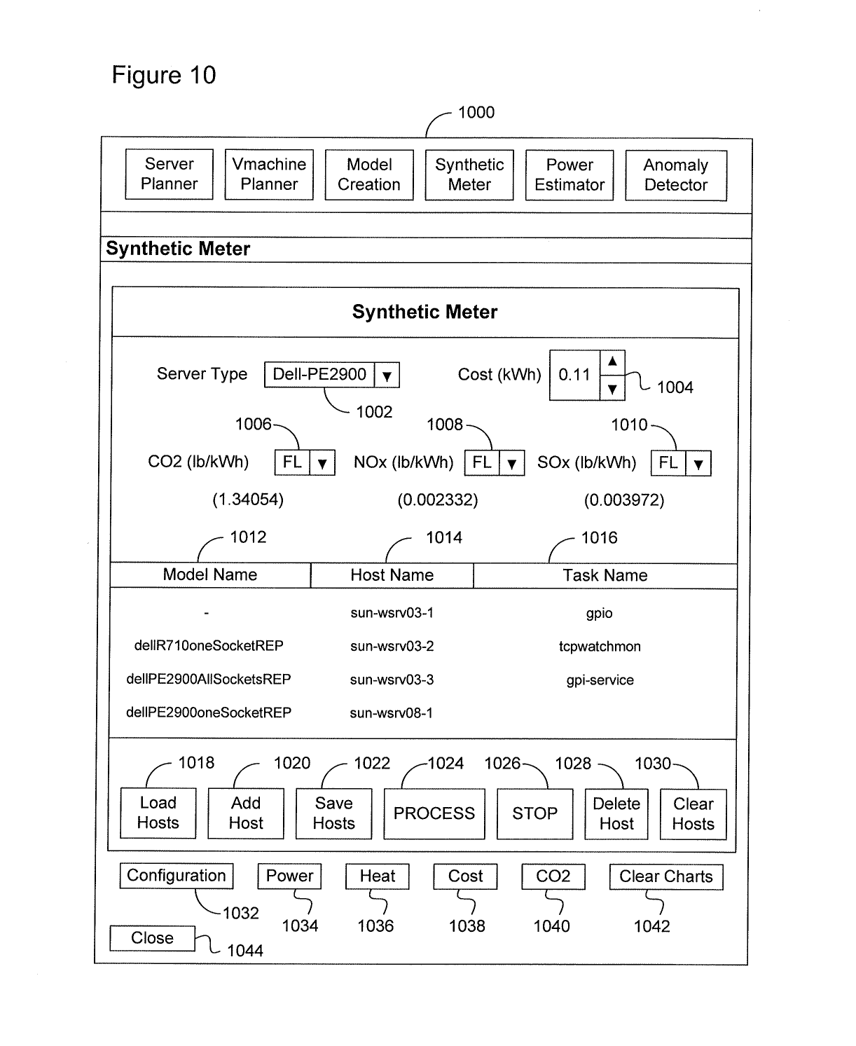

FIG. 10 illustrates one implementation of an exemplary Page View 1000 corresponding to the Synthetic Meter implementation consistent with the present invention. The selections available in Server Type Dropdown Menu 1002 correspond to models for hardware platforms profiled and modeled previously. In one implementation, there may be multiple models predefined for each server type previously characterized. Cost 1004 represents the regional cost of power for a user. In one implementation, cost is measured in dollars per kWh. In another implementation, the default value is the average cost of power in the United States, e.g. $0.11/kWh. CO2 Dropdown Menu 1006, NOx Dropdown Menu 1008, and SOx Dropdown Menu 1010 display the annual emission rates for carbon dioxide, nitrous monoxide and the various nitrous polyoxides, and sulfur monoxide and the various sulfur polyoxides; in the state selected by the user from the respective dropdown menus, with the respective values shown below the respective dropdown menus. In one implementation, emissions are measured in lbs/kWh. In another implementation, the source of this data is the eGRIDweb Version-2007.1.1.

Model Name 1012 displays the models defined by the user in the entry cell selected. The user may highlight, for example by clicking, which model the user wishes the system to use for that session. In one implementation, only model names suffixed with “REP” may be used for predictions. In that implementation, all other models must first be created using the Model Generation implementation of the PCP, described below in relation to FIG. 16. In another implementation, user defined models supersede any server type selected from Server Type Selection Dropdown Menu 1002 in the same session. Host Name 1014 displays the name of the host for which the metering and prediction are to occur. This host may be a virtual machine or a physical machine. Task Name 1016 displays the name of the task running on the entered host for which metering and prediction are desired. In one implementation, if no task is entered the system performs metering and prediction for the entire host/machine.

Clicking Load Hosts 1018 loads into the data grid (the window where the user enters data) previously defined models, hosts/machine names, and corresponding business application names or tasks. Clicking Add Host 1020 inserts a new entry into the data grid. Clicking Save Hosts 1022 saves the contents of the current data grid, for example into an XML file, for later retrieval and/or use. Clicking PROCESS 1024 starts the metering and prediction for the hosts and/or tasks defined in the displayed data grid. Clicking STOP 1026 stops currently running metering and prediction. Clicking Delete Host 1028 deletes selected rows from the displayed data grid. Clicking Clear Hosts 1030 clears all entries from the displayed data grid.

Clicking Configuration 1032 opens Page View 1000, the initial parameter definition screen of the Synthetic Meter implementation. Clicking Power 1034 displays the chart containing power usage estimates for the entered parameters. In one implementation, power is measured in kW. Clicking Heat 1036 displays the chart containing dissipated heat estimates for the entered parameters. In one implementation, heat dissipated is measured in BTU. Clicking Cost 1038 displays the chart containing cost estimates for the entered parameters. In one implementation, this is measured in U.S. dollars. Clicking CO2 1040 displays the chart containing the regional CO2, SOx, and NOx output emission rate estimates for the entered parameters. In one implementation, these are measured in lbs/year. In another implementation the regions defined may be U.S. states. In one implementation the user may zoom in to a specific data point in any of the aforementioned charts, opened by clicking Power 1034, Heat 1036, Cost 1038, or CO2 1040, by clicking on the desired point within the given chart. Clicking Clear Charts 1042 closes all charts currently displayed and displays the configuration screen, Page View 1000. Clicking Close 1044 closes the Synthetic Meter window.

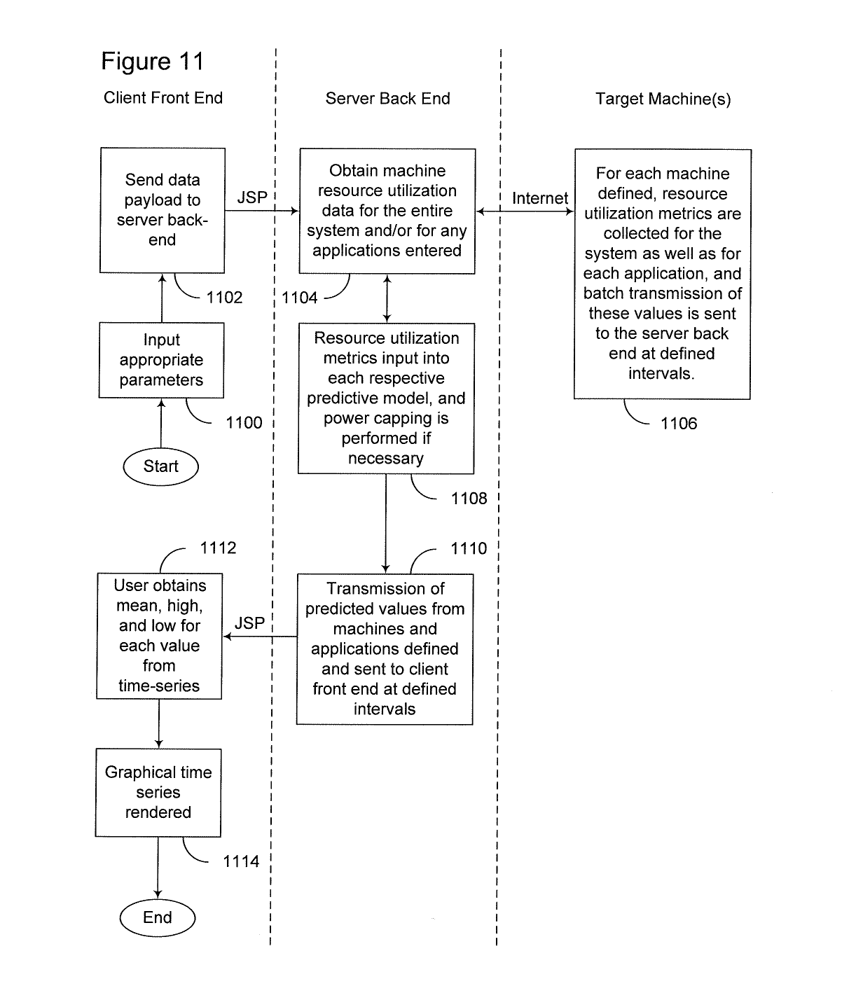

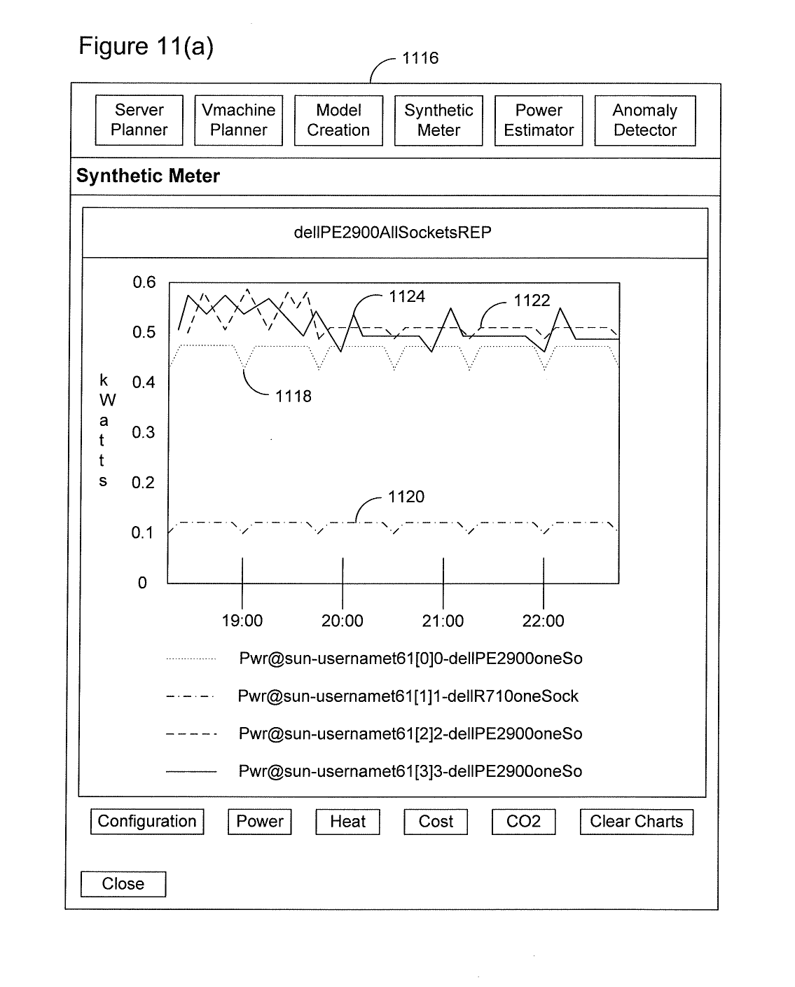

FIG. 11 illustrates steps in an exemplary method of using the Synthetic Meter implementation consistent with the present invention. First, the user inputs values for various parameters including, for example, model name, machine name or IP address, and the specific business application or task to be metered, if desired (step 1100). Metering a machine entails the continuous monitoring of the resource (CPU and memory) utilization (as percentages) by such machine and/or specific application running on such machine. It is possible to meter an entire machine and/or specific business applications simultaneously by simply entering the same entry lines multiple times, as needed, but changing either the application name or task name. Additionally, in one implementation, each machine is associated with a model, making it possible to meter the same machine using different models. Next, the user sends the data payload, for example via HTTP protocol, to the server back end (step 1102). The data payload is sent from the client front end to the server back end, and on the server back end the software obtains machine resource utilization data, for example CPU power and/or memory used, for the entire host/machine and/or for any specific application(s) to be metered (step 1104). The metrics, including CPU and memory utilization as percentages per machine and/or machine/application, may be collected every second but the power predictions are batch transmitted to the client front end at defined intervals, for example every 10 or 15 seconds, in order to reduce network traffic (step 1106). The host/machine resource usage metrics from the targeted host may be obtained by any appropriate scripts, applications, or other data collection methods and/or services available. For example, Windows Management Interface (“WMI”) may be used to obtain resource usage metrics in Windows, the Top utility in Linux, or the EXSTop utility in VMware Hypervisor. The resource usage metrics may be provided by any appropriate data collection service and/or agent, for example DCIM service processors and/or DCIM appliances.

After the resource utilization metrics are collected and sent back to the server back end via the internet, the resource utilization metrics for each machine, as well as each individual application, are input into each respective predictive model and power capping is performed if necessary (step 1108). Power capping limits the amount of power consumed and/or resources (CPU and Memory) utilized by a host/machine and/or the business applications running on such machine. In one implementation, the limitation is enforced via software only; for example by tuning the application/task execution priority and core affinity, core affinity is the number of CPU cores available for use by such application/task when executing; and does not use hardware. In one implementation, if the user has enabled the power capping feature and the model determines that the resource utilization is higher than the defined usage limit, power capping would take place. Once the resource utilization metrics are input into the respective models, the predicted power consumption values are sent in batch transmissions to the client front end at defined intervals, for example every 15 seconds (step 1110). Thus, the user may view the predicted values for each of the time-series modeled (step 1112). In one implementation, the synthetic meter “stacks” multiple time-series for each corresponding entered model on the same chart for comparison purposes. In one implementation, the predicted values view includes the mean, high and low predictions for each value obtained from the prediction batch update sent in step 1110. In one implementation the values viewed in step 1112 may be represented in graphical form. In one implementation, zooming capabilities and smart data tips for each time series point are instantly available upon cursor positioning. In another implementation, each machine and/or individual application modeled may be plotted on a single graph or chart. The meter may continuously update the chart(s) as new batch transmissions arrive from the server back end at each defined interval. In one implementation, these updates overwrite the oldest interval on the chart, shifting the entire time series chronologically to display the most recent prediction batch(es). FIG. 11(a) illustrates one implementation of an exemplary Page View 1116 corresponding to this implementation of the Synthetic Meter. Line 1118, Line 1120, Line 1122, and Line 1124 represent the predicted values of power usage for the defined work profiles. In one implementation, mousing over Line 1118, Line 1120, Line 1122, or Line 1124 causes the system to display statistics for the data point moused over as well as for the entire line. For example, the system may display the work profile plotted, the value of the point moused over, and the mean, high, and low values measured for that work profile.

The Power Estimator enables the prediction of power consumption, heat dissipation, regional power costs, and regional greenhouse gas effects based on operational server resource metrics previously collected from the entered machine/host name(s) and stored in XML files, for example. This enables the user to obtain accurate knowledge of a server's operational power consumption past trends, which may be compared to “what-if” time varying workloads provided by the Server Planner or VMachine Planner, workloads defined by the Server/VMachine Planner and any Workload Profiles defined within a given scenario's time interval, for example.

The Power Estimator feature of PCP allows the power, heat, cost, and CO₂ emission predictions for previously measured independent variables, for example CPU utilization and memory utilization, as well as dependent variables, for example power utilization. This data is known as “supervised test data” in the art of machine learning, and power consumption, the dependent variable, does not have to be measured. The Power Estimator will request predictions from, in one implementation, every model defined for a particular server type entered, and statistically infer the best predictions from the models consulted. On the other hand, if a user enters the name of its own custom-generated model, then the Power Estimator obtains the power consumption estimates from that model. In cases where power was also measured via a meter attached to the host/machine under study, the power consumption predictions may be graphically and statistically compared to the actual power measurements obtained within the same chart(s).

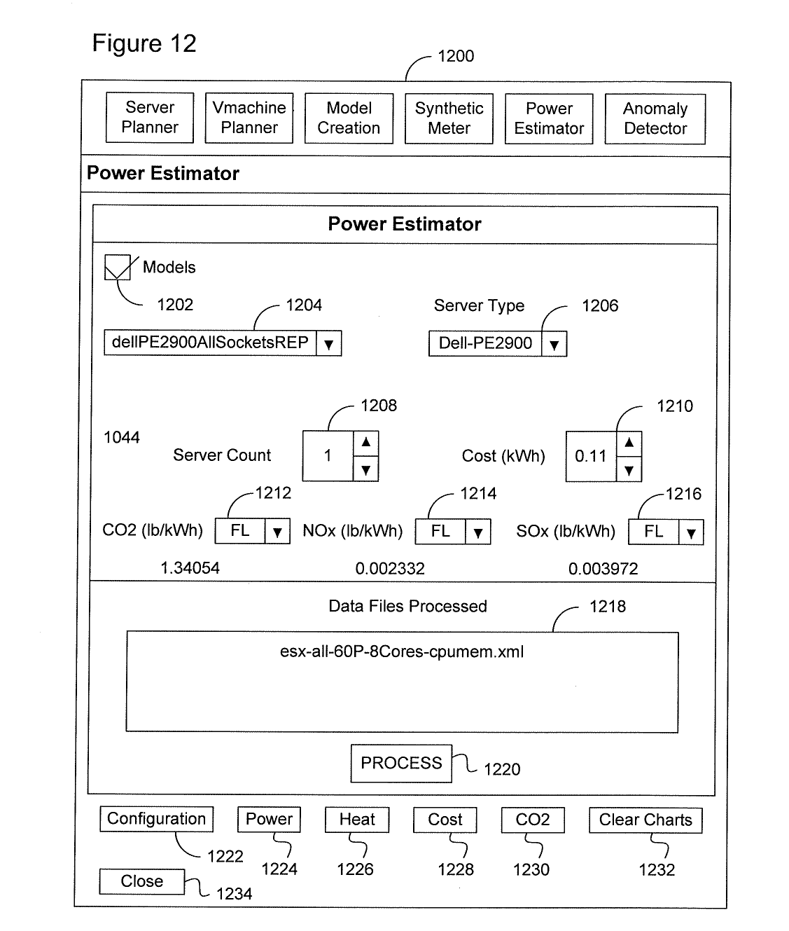

FIG. 12 illustrates one implementation of an exemplary Page View 1200 corresponding to the Power Estimator implementation consistent with the present invention. When Checkbox 1202 is highlighted, for example by clicking on it, models defined by the user may be displayed in the Model Selection Dropdown Menu 1204. The user may then select the model used in the session from Model Selection Dropdown Menu 1204, for example by clicking on it. In one implementation, only the model names suffixed with “REP” may be used for predictions. In that implementation, all other models must first be created using the Model Generation implementation of the PCP, described below in relation to FIG. 16. In another implementation, user defined models supersede any server type selected from Server Type Selection Dropdown Menu 1206 in the same session. The selections available in Server Type Dropdown Menu 1206 use models for hardware platforms profiled and modeled previously. In one implementation, there may be multiple models predefined for each server type previously characterized. Server Count 1208 represents the number of servers modeled. In one implementation, the default value of this field is 1. The value may be changed, for example, to model a rack of servers comprising multiple servers of the same type. It is also possible to consolidate the number of servers to be modeled. For example, instead of modeling 80 servers running at 70% workload, the user may instead model only 50 servers running at 35% workload. Cost 1210 represents the regional cost of power for a user. In one implementation, cost is measured in dollars per kWh. In another implementation, the default value is the average cost of power in the United States, e.g. $0.11/kWh. CO2 Dropdown Menu 1212, NOx Dropdown Menu 1214, and SOx Dropdown Menu 1216 display the annual emission rates for carbon dioxide, nitrous monoxide and the various nitrous polyoxides, and sulfur monoxide and the various sulfur polyoxides; in the state selected by the user from the respective dropdown menus, with the respective values shown below the respective dropdown menus. In one implementation, emissions are measured in lbs/kWh. In another implementation, the source of this data is the eGRIDweb Version-2007.1.1.

Data Files Processed Menu 1218 displays data files already processed. Once the input parameters have been entered, clicking PROCESS 1220 selects the input file and invokes the selected models.

Clicking Configuration 1222 opens Page View 1200, the initial parameter definition screen of the Power Estimator implementation. Clicking Power 1224 displays the chart containing power usage estimates for the entered parameters. In one implementation, power is measured in kW. Clicking Heat 1226 displays the chart containing dissipated heat estimates for the entered parameters. In one implementation, heat dissipated is measured in BTU. Clicking Cost 1228 displays the chart containing cost estimates for the entered parameters. In one implementation, this is measured in U.S. dollars. Clicking CO2 1230 displays the chart containing the regional CO2, SOx, and NOx output emission rate estimates for the entered parameters. In one implementation, these are measured in lbs/year. In another implementation the regions defined may be U.S. states. In one implementation the user may zoom in to a specific data point in any of the aforementioned charts, opened by clicking Power 1224, Heat 1226, Cost 1228, or CO2 1230, by clicking on the desired point within the given chart. Clicking Clear Charts 1232 closes all charts currently displayed and displays the configuration screen, Page View 1200. Clicking Close 1234 closes the Power Estimator window.

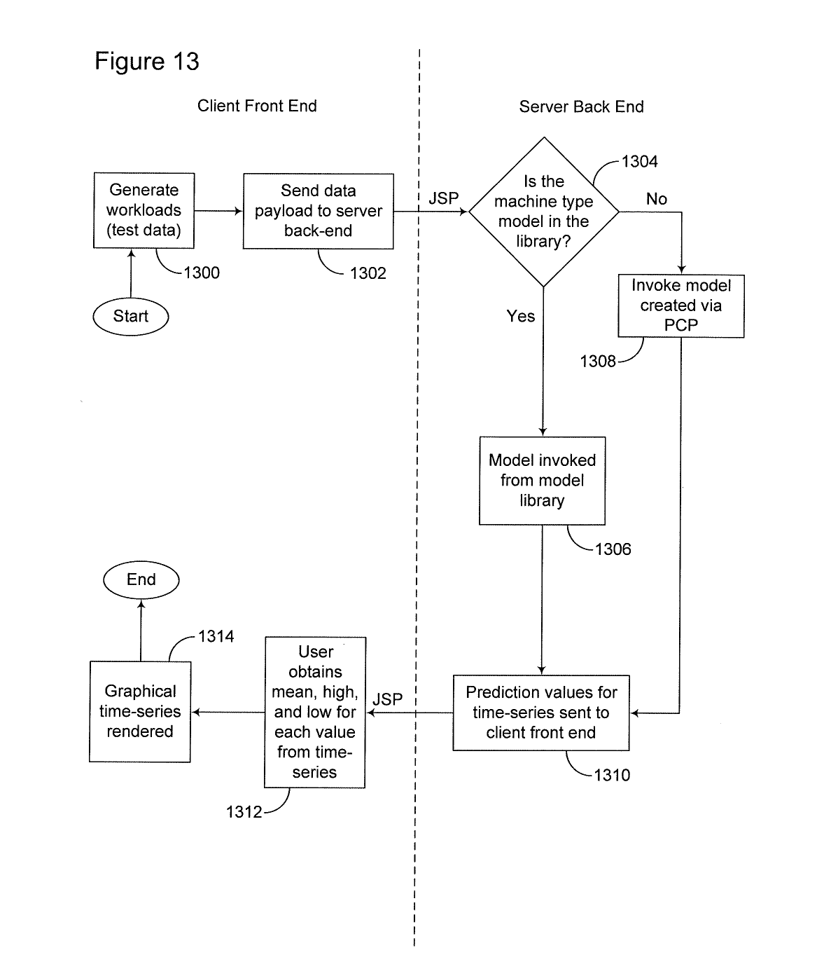

FIG. 13 illustrates steps in an exemplary method of using the Power Estimator implementation consistent with the present invention. A user may input the file name, which contains the resource utilization metrics collected from the machine under study, to generate test data (step 1300). Next, the user sends the data payload, for example time-series, machine model, machine type, and CPU core count, via HTTP protocol for example, to the server back end (step 1302). The data payload is sent from the client front end to the server back end, and on the server back end the software determines if the model library, which stores models, contains a model previously generated for the entered machine type (step 1304). If the library does contain such a model, that model may be invoked (step 1306). A process, described in further detail below in relation to FIG. 17, statistically derives a predicted value from the ensemble of the model's predictions for each data point. If in step 1304 the software determines that the model library does not contain a model previously generated for the entered machine type, it may be used to invoke a model created via PCP's Model Creation feature (step 1308). Model creation is described in further detail below in relation to FIGS. 8 & 9. Additionally, PCP model creation (step 1308) may supersede model invocation from the model library (step 1306) when the machine training data can be synthetically generated. PCP generated models may handle a wide variety of workloads. After an appropriate model is invoked, the model generates prediction values for the data entered. These power consumption prediction values for the (10) time-series are sent back to the client front end (step 1310). The client front end then displays a representation of the results for each value from each of the multiple time-series (step 1312). In one implementation, this representation graphically plots the mean, high, and low prediction for each value from the multiple time-series which may be given. Each time series predicted value may be graphed, and may be used to calculate estimated power usage in various units, including actual power units, cost, or emissions values. Finally, graphical time-series may be rendered (step 1314). In one implementation, zooming capabilities and smart data-tips for each time-series point may be instantly available upon cursor positioning. In other implementations, multiple time series from different resource utilization files and/or from different models may be stacked on the same chart for comparison. If the resource utilization data contains actual power measurements, the power measurements will be plotted on a separate time series within the chart. This allows the comparison of the predicted and measured power consumptions graphically and statistically.

The Anomaly Detector component of the PCP uses resource utilization pattern recognition to effect monitoring and classification of any potential anomalous resource utilization by any machine, virtualized or non-virtualized, and/or the business applications running on such machine. The Anomaly Detector detects potential intrusions in the system by detecting anomalous power and resource utilization fluctuations. The pattern recognition models can also detect anomalous resource utilization on any process or thread started on the machine, including OS processes and threads. For example, the Anomaly Detector may be used to detect malware infected OS processes and/or tasks. In order to lessen the frequency and probability of “false-positives,” or false alarms, a workload threshold can be defined to indicate the maximum expected workload of a machine and/or application(s). A manufacturer or user may also set a default value to be applied when such threshold has not been defined. User tunable “delta,” or difference, factors, each factor representing an allowable variability in the difference between the threshold and measured values, may be used to decide when thresholds have been truly exceeded.

In one implementation, there are three layers of checks, or filters, to classify detected anomalies: (1) the workload threshold, (2) statistical derivatives calculated from additional input/output (“I/O”) activity metrics including I/O activity at the system, e.g., cache, activity, system wide and individual applications' processor, file system, and memory activity metrics, including corresponding threads' activity metrics, and application levels from the entire machine, from the network interface connections (“NICs”), e.g., network adapters' activity metrics including errors and retries, and from the storage subsystem(s), e.g., logical and physical disks' activity metrics including corresponding NICs' activity belonging to SANs and iSCSI storage controllers, and finally, (3) a check against a rule-based time sensitive, or aged, direct access repository of false-positive event exceptions, including each triplet composed of the classification model, the host/machine name or IP address, and the respective application. This repository may comprise a hash map class, providing deterministic average times for reads and writes, residing in memory and periodically stored to disk. In one implementation, this repository is dynamically updated when a user labels a positive event as a false-positive. To curtail the growth of the repository, each entry may be time-stamped when added to allow eventual removal after a user defined “expiration” date/period. In one implementation, when repository rules reach their life time period, the user is asked if such rules can be removed. If the user answers in the negative, the PCP may set extended life time periods on those rules.

It may be possible to monitor the same machine and/or business application(s) multiple times using different classification models by simply entering the same host/machine name multiple times with each entry having different classification models. This allows the user to dynamically assemble a majority voting of “anomaly detection experts” (by virtue of the different selected models) that can help identify false-positive events. An unusually high rate of false-positives for a sustained time may indicate that a particular machine configuration has changed significantly in hardware and/or software. When this happens, the classification model for that machine may be regenerated to account for the changes in the machine configuration so that the Anomaly Detector may not continue to generate a higher rate of false-positive events.

Resource utilization metrics may also be mined to identify operational reliability of hardware and associated applications. The mined data may include the latest resource utilization, I/O activity, and statistical derivatives, which may include for example the mean, mode, high, low, and/or standard deviation for each significant metric collected regularly, such as disk, network, interprocess communication, thread management, etc. and related metrics obtained from the O/S. Anomalous events contain traces from the source machine to help understand the root cause of the anomaly. These traces comprise the statistical information including the derivatives mentioned previously as well as the machine name, the classification model used, and the application name. An anomaly thus can also indicate that a machine is failing or near failure, and/or that an application is malfunctioning.

The Anomaly Detector also enables users to identify and/or classify the type of workload, for example transactional, computational, CPU only or memory only workloads, handled by individual applications. This ability has value in controlling resource costs through resource management and/or reallocation of assets. For example, memory intensive applications may be shifted to slower CPUs systems which cost less to operate than fast CPUs that require high energy usage. Additionally, workload types may be aggregated to obtain a hierarchy of most frequently handled workloads at the machine level. This allows optimization of machine configuration as well as predictions of current and future performance and reliability.

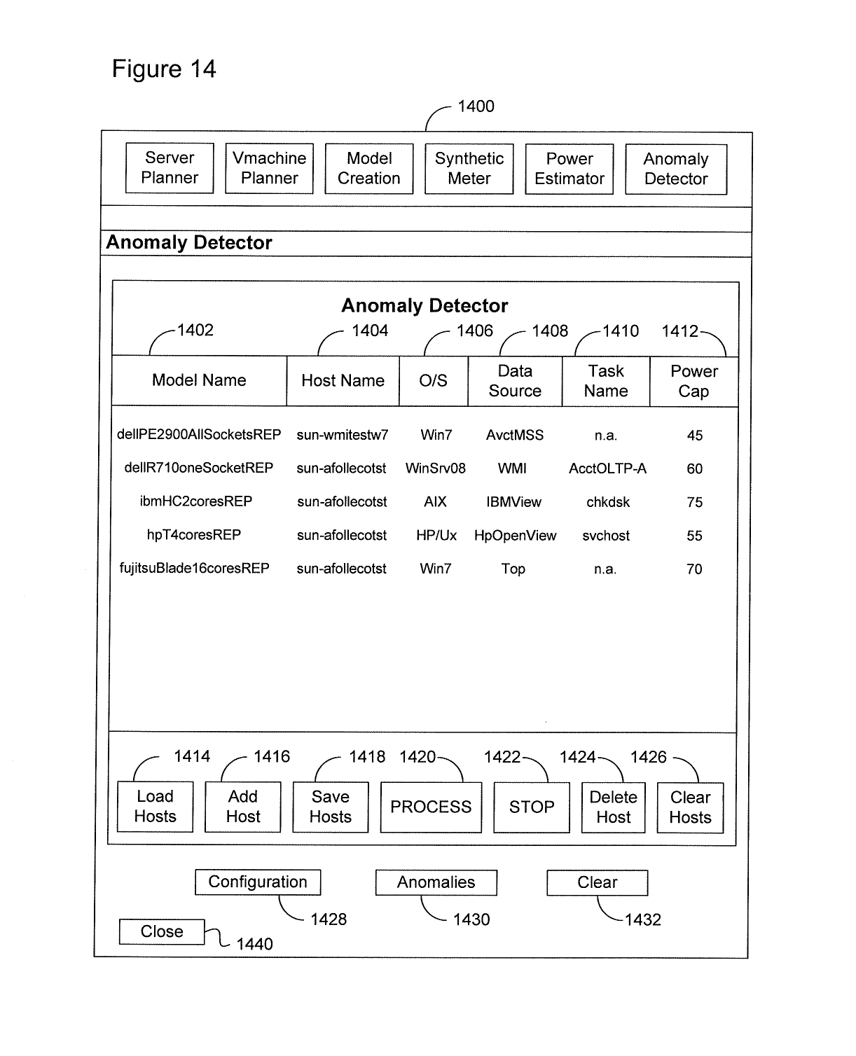

FIG. 14 illustrates one implementation of an exemplary Page View 1400 corresponding to the Anomaly Detector implementation consistent with the present invention. Model Name 1402 displays the models defined by the user in the entry cell selected. The user may highlight, for example by clicking, which model the user wishes the system to use for that session. In one implementation, only model names suffixed with “REP” may be used for predictions. In that implementation, all other models must first be created using the Model Generation implementation of the PCP, described below in relation to FIG. 16. Host Name 1404 displays the name of the host for which the anomaly detection is to occur. This host may be a virtual machine or a physical machine. O/S 1406 displays the operating system running on the host/machine. Data Source 1408 displays the name of the service providing the corresponding resource utilization metrics, as mentioned previously. In one implementation, these metrics are used internally within the system only and are not exposed to the user. Typically the metrics are only stored for “false-positive” events, the trace information for such events would include some of the metrics as well as the statistical derivatives computed by the Anomaly Detector, as mentioned previously. Trace information and other statistics are used to verify and store false positives for anomaly detection purposes. In one implementation, metrics collection takes place at one second intervals. Task Name 1410 displays the name of the task running on the entered host for which anomaly detection is desired. In one implementation, if no task is entered the system performs anomaly detection for the entire host. Power Cap 1412 shows the maximum workload allowed on the host machine, task, or application. In one implementation, this will be represented as a percentage of the maximum power draw of that machine or application. In another implementation, the default minimum allowable load will be zero, but this value may be configurable by the user.

Clicking Load Hosts 1414 loads the previously defined models, including the rest of the fields of the data grid, into the screen/window data grid. Clicking Add Host 1416 inserts a new entry into the data grid. Clicking Save Hosts 1418 saves the contents of the current data grid, for example into an XML file, for later retrieval and/or use. Clicking PROCESS 1420 starts the anomaly detection for the hosts and/or tasks defined in the displayed data grid. Clicking STOP 1422 stops the currently running anomaly detector. Clicking Delete Host 1424 deletes any selected rows from the displayed data grid. Clicking Clear Hosts 1426 clears all entries from the displayed data grid.

Clicking Anomalies 1430 displays any anomalies or alarms detected by the system. In one implementation, this may be limited to anomalies or alarms detected within a defined time period, for example the last 10 minutes. Clicking Clear 1432 closes the chart currently displayed and displays the configuration screen, Page View 1400. Clicking Close 1434 closes the Anomaly Detector window.

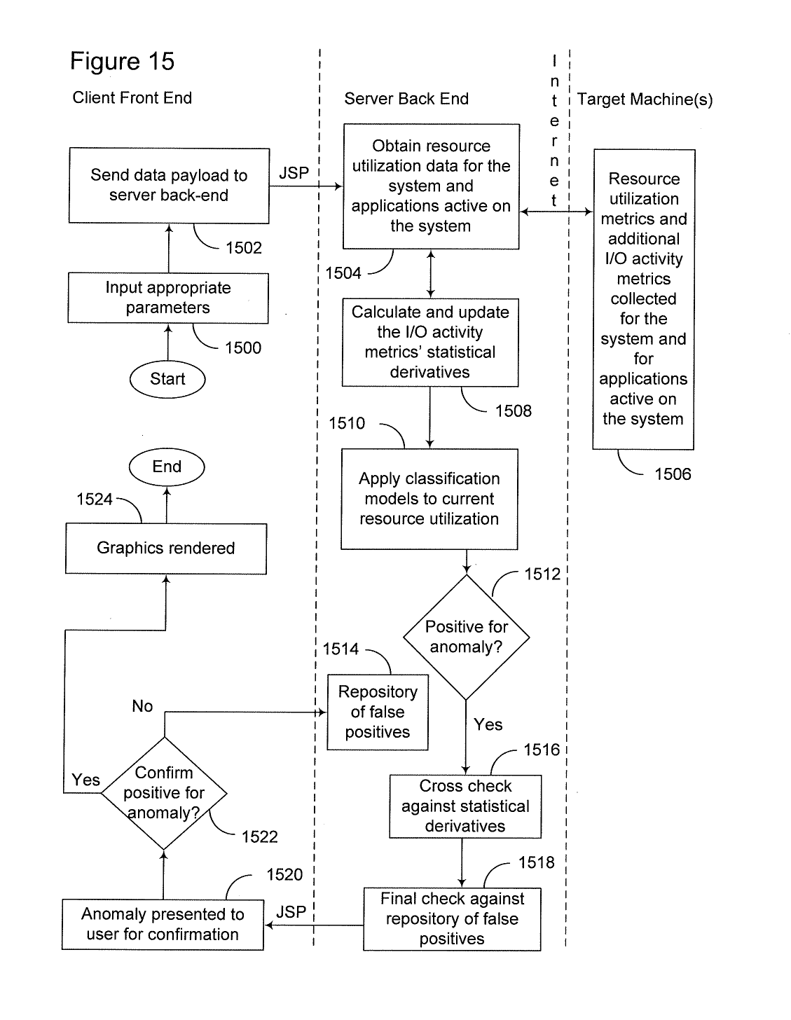

FIG. 15 illustrates steps in an exemplary method of using the Anomaly Detector implementation of the present invention. First, the user populates the parameter fields in the displayed data grid of the Anomaly Detector Implementation. Referring to the example of FIG. 14, these fields may include Model Name 1402, Host Name 1404, O/S 1406, Data Source 1408, Task Name 1410, and Power Cap 1412 (step 1500). Next, the data payload is sent, for example via HTTP protocol, over JSP, to the server back end (step 1502). Once the data reaches the server back end, the Anomaly Detector obtains resource utilization data for the entire system as well as for applications active on the system (step 1504). The Anomaly Detector requests and receives said resource utilization metrics and additional I/O activity metrics, which are collected for the system and, in one implementation, for each application active on the system (step 1506), via a suitable internet protocol, for example TCP/IP. Resource utilization metrics may include, for example, CPU and memory utilization, while other I/O activity metrics may include, for example, I/O activity at the system and applications levels from the system, I/O activity at the system and applications levels from the NICs, and/or I/O activity at the system and applications levels from the storage subsystem. After obtaining this information in step 1504, the Anomaly Detector calculates and updates the I/O activity metrics' statistical derivatives (step 1508). In one implementation, these derivatives may be stored in memory. These derivatives may be used to profile the workload and resource utilization of the machine and/or individual applications active on the machine. Derivatives may be used as additional input to classification models, for anomaly detection purposes. Classification models, machine learning models created to help identify anomalous resource utilization in a machine and/or business applications running on such machine, are applied to the current resource utilization for the system and/or application undergoing anomaly detection (step 1510). This allows the Anomaly Detector to apply classification models, which compare the current resource utilization of the system and/or application to workload thresholds defined for that system and/or application using user tunable delta factors, and thereby detect anomalous resource utilization (step 1512). If no anomalies are detected, data may be aged immediately and discarded, or could be stored temporarily to be used as the previous values to be compared with newer values for the next sampling period. If the resource utilization metrics exceed the thresholds and seem anomalous, the Anomaly Detector triggers a cross-check against the statistical derivatives of the machine and/or active applications (step 1516). If said metrics exceed the statistical derivatives, they are then checked against the repository of false positives, which resides on the server back end (step 1518). In one implementation, this repository is rule based and aged, or time-sensitive. When a machine and/or application is found to be anomalous, notification is sent to the client front end along with the metrics and derivatives and the workload types handled, for user confirmation of an anomaly (step 1520 and step 1522). If the user determines that there is no anomaly and denies to confirm an anomaly, the data are sent to the repository of false positives which may reside on the server back end (step 1514). Finally, if the user confirms that an anomaly has occurred in step 1522, graphical time-series may be rendered (step 1524).

FIG. 16 illustrates steps in an exemplary method of using the Gamut workload simulator to ultimately generate a machine learning model consistent with methods and systems in accordance with the present invention. Gamut is used to simulate a wide range of workloads (e.g., 5% to 90% at 5% increments) on a targeted machine. This is used for systems that have not been workload characterized previously and consist of a hardware configuration unlike other systems modeled already; e.g., blade systems may have to be fully characterized because these are architecturally (hardware) significantly different from typical monolithic servers. The target system may run Linux in order to install the Gamut simulator (step 1600). If the target system is not running Linux, the user must start Linux (step 1602). The user must also ensure that the Gamut simulator is installed on the target system (step 1604). If the Gamut simulator is not installed on the target system, the user should install it (step 1606). It should be appreciated that in other exemplary methods, steps 1604 and 1606 may be performed prior to steps 1600 and 1602. Once the target system is running Linux and the Gamut simulator is installed on the target system, if the Gamut simulator is not calibrated for the target system, the user calibrates it for the target system before continuing (step 1608). Once the Gamut simulator is calibrated, the user sets up the master control scripts necessary to induce sufficiently precise workloads on the target system (step 1610). Scripts are used in Gamut to define the inputs and workloads (based on CPU, memory, and network utilization). Because Gamut operates via pre-planned activity at the CPU, Memory, Disk, and NIC levels, workloads are defined in such worker scripts. As the system is loaded, values for the independent (CPU and memory utilization) and dependent (power consumption) variables are recorded at a set time interval, for example every second, and used to create the training data for the machine learning algorithms (step 1612). The models generated via the Weka data mining and machine learning library toolkit can then predict the power consumption based on the values of the independent variables which are either generated synthetically by the PCP or measured from an operational system. After creating appropriate training data (loads) for the CPU and system memory, the user starts the power meter to record and log the amount of power consumed by the machine while handling the Gamut workloads at regular intervals, for example every second (step 1614). The power meter records the values of the dependent variable, power consumption, needed for the training data which will be used to train the machine learning algorithms. Once the power meter starts to log regular readings, the user starts Gamut via the master control scripts to induce the desired workloads on the CPU (step 1616). In other implementations, the user may start and run multiple Gamut workloads simultaneously in order to induce time-varying workloads that approach other realistic operational scenarios and generate high quality training data for the machine learning algorithms. After the desired workload has been applied to the target system, the user parses, formats, and merges the Linux TOP utility output, that utility being used to record the machine resource utilization (CPU and Memory, the independent variables) during the application of the Gamut workloads, and the power meter output files containing the power consumed (e.g., measured in watts) during the application of the Gamut workloads in order to generate the training data for use in the machine learning algorithms (step 1618). In one implementation, both the independent and dependent variable values are included in the merged file to allow the machine learning algorithms to be trained from this data. Once a model is generated, that model may be tested or used with synthetically generated independent variable values generated by the PCP or with real independent variable values recorded from an operational system. In the case of predictive modeling, the models can then predict the value of the dependent variable from the values of the independent variable(s). Once a training file is created, the Weka machine learning library toolkit can be applied to that training file to induce machine learning modeling (step 1620). Details on the use of the Weka toolkit user interface are disclosed at http://www.cs.waikato.ac.nz/ml/weka/, which is hereby incorporated by reference. The Weka machine learning algorithms are selected based on the accuracy and consistency of the results (e.g., predictions of the dependent variable, the power consumed at certain levels of resource utilization by the machine handling pre-determined workloads) and may be trained with the training file compiled in step 1618. Potential training algorithms include the REPTree and M5Rules algorithms. The REPTree algorithm is known for its speed and low memory consumption. It uses multivariate non-linear regression decision trees with error reduction and tree pruning in order to curtail memory/resource utilization and speed up tree generation. The M5Rules algorithm is a rule based algorithm that uses the well known M5 algorithm for generating and updating rule sets dynamically. For larger size training data sets, it is not as fast as the REPTree algorithm and takes longer to generate the final rule set.

FIG. 17 illustrates steps in a method for assembling various individual model predictions into a single overall prediction as discussed above in relation to the Server Planner, VMachine Planner, and Power Estimator implementations of the present invention. First, for every instance of the resource utilization data the system invokes every model for that machine type using the current resource utilization data (step 1700). The system then stores the predictions from the models invoked in step 1700 in the system memory (step 1702). There may be multiple predictions because there may be multiple versions, for example 10, of each time-series generated by the client front end in order to achieve better statistical significance in the predictions. Therefore, there may be multiple sets of predictions, for example 10, transmitted by the server back end to the client front end. After storage, for each individual stored prediction, the system calculates the mean for that prediction based on the number of models used from that machine type (step 1704). Next, the system bubble sorts the prediction array (step 1706), and calculates the mode of that array (step 1708). Once the mode is calculated, the system finds the location of that mode in the prediction array for each respective model (step 1710). Next, the system calculates the standard deviation of the prediction array (step 1712). Once the mean and standard deviation are known, the mean can be adjusted by subtracting the ratio of the standard deviation and a smoothing factor for CPU metrics from the mean (step 1714). The smoothing factor may be entered by the user, and may have a default value, e.g., 90%. It may be used to slightly adjust the sample mean because it typically can be considered a conservative estimate. Next, the system calculates a local or temporary mean only (e.g., a statistical value used within the process to predict power values based on workloads) for the predicted values with equal modes (step 1716). The sample mean is then compared to the local mean (step 1718). If the sample mean is greater than the local mean, then the local mean is recorded as the final prediction (step 1720). If the local mean is greater than the sample mean, then the sample mean is recorded as the final prediction (step 1722).

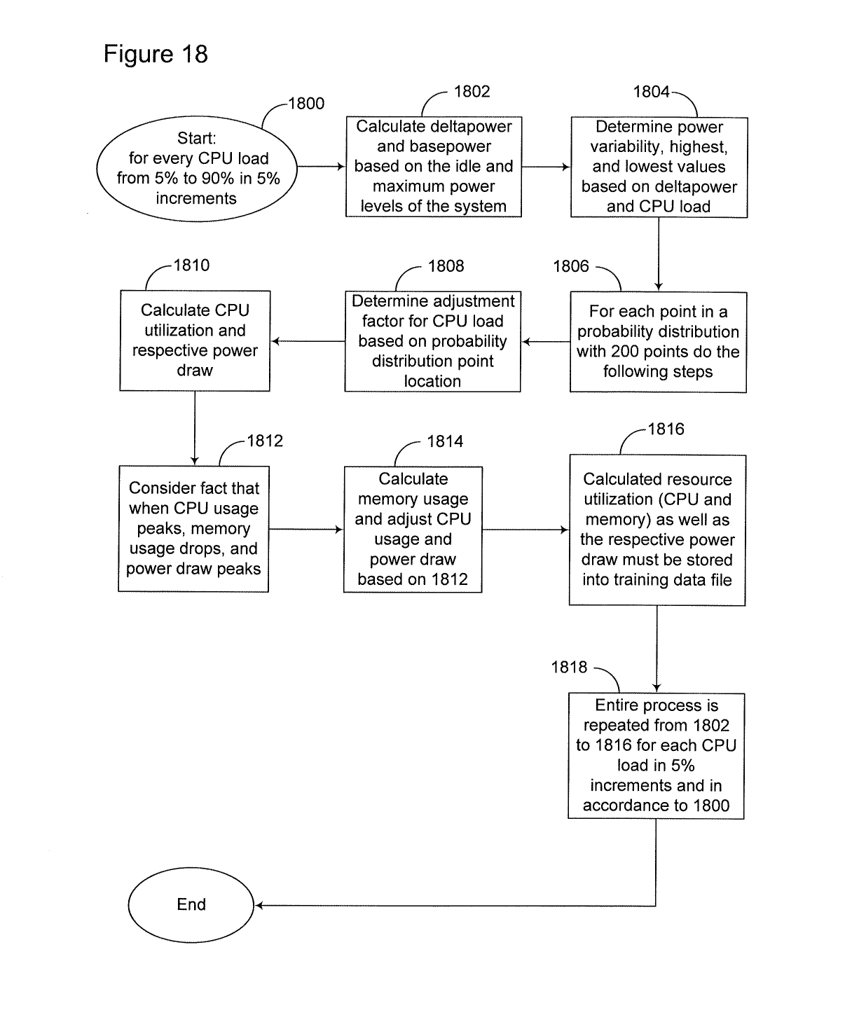

FIG. 18 illustrates steps in a method for synthetically generating supervised training data, which is subsequently used to generate the machine learning models for the model creation feature of the PCP, based on a wide range of workloads where independent (CPU and Memory utilization as percentages) and dependent (the power draw in watts respective to each set of values from CPU and Memory usage) variable values are generated in accordance with methods and systems consistent with the present invention. In some implementations, the coefficients listed herein may be tunable or configurable from XML files. Numeric values may ultimately be required to generate training data.

This system may generate supervised training data for every CPU load from 5% to 90%. In some implementations, this may be performed in 5% increments, for example at 5% CPU load, 10% CPU load, 15% CPU load, etc. First, the system calculates the deltapower and base power based on the idle power level and maximum power level of the system (step 1800). For example, in some implementations, if deltapower is less than 100.0, basepower=deltapower*0.55. Otherwise, basepower=deltapower*0.85.

Next, the system determines the CPU variability for every CPU value from 5% to 90% workload in 5% step increments with a variability of +/−5% (step 1802). An example of code for this step is as follows—

if ( cpu >= 5 and cpu <= 20 ) {

powervar = 0.06;

| | |
|---|---|
| } | else if ( cpu >= 20 and cpu <= 35 ) { |
| | if ( deltapower < 100.0 ) |

powervar = 0.1;

else

powervar = 0.07;

| | |
|---|---|
| } | else if ( cpu >= 35 and cpu <= 50 ) { |
| | if ( deltapower < 100.0 ) |

powervar = 0.4;

else

powervar = 0.1;

| | |
|---|---|
| } | else if ( cpu >= 50 and cpu <= 65 ) { |
| | if ( deltapower < 100.0 ) |

powervar = 0.42;

else

powervar = 0.1;

| | |
|---|---|
| } | else if ( cpu >= 65 and cpu <= 80 ) { |
| | if ( deltapower < 100.0 ) |

powervar = 0.64;

else

powervar = 0.12;

| | |
|---|---|
| } | else if ( cpu >= 80 and cpu <= 90 ) { |
| | if ( deltapower < 100.0 ) |

powervar = 0.8;

else

powervar = 0.08;

}

Then, the system determines the range of power estimation based on the delta difference between idle and maximum powers based on the CPU load specified in step 1800 and the deltapower calculated in step 1802 (step 1804). An example of code for this step is as follows—

if ( cpu_i <= 10 ) {

if ( deltapower < 100.0 )

lopower = deltapower * 0.18; hipower = deltapower *

0.33;

else

lopower = deltapower * 0.16; hipower = deltapower *

0.64;

} else if ( cpu_i > 10 and cpu_i <= 20 ) {
if ( deltapower < 100.0 )

lopower = deltapower * 0.20; hipower = deltapower *

0.35;

else

lopower = deltapower * 0.26; hipower = deltapower *

0.68;

} else if ( cpu_i > 20 and cpu_i <= 30 ) {

if ( deltapower < 100.0 )

lopower = deltapower * 0.25; hipower = deltapower *

0.38;

else

lopower = deltapower * 0.36; hipower = deltapower *

0.71;

} else if ( cpu_i > 30 and cpu_i <= 40 ) {

if ( deltapower < 100.0 )

lopower = deltapower * 0.28; hipower = deltapower *

0.4;

else

lopower = deltapower * 0.46; hipower = deltapower *

0.73;

} else if ( cpu_i > 40 and cpu_i <= 50 ) {

if ( deltapower < 100.0 )

lopower = deltapower * 0.3; hipower = deltapower * 0.5;

else

lopower = deltapower * 0.50; hipower = deltapower *

0.75;

} else if ( cpu_i > 50 and cpu_i <= 60 ) {

if ( deltapower < 100.0 )

lopower = deltapower * 0.3; hipower = deltapower * 0.6;

else

lopower = deltapower * 0.57; hipower = deltapower *

0.79;

} else if ( cpu_i > 60 and cpu_i <= 70 ) {

if ( deltapower < 100.0 )

lopower = deltapower * 0.4; hipower = deltapower * 0.7;

else

lopower = deltapower * 0.64; hipower = deltapower *

0.81;

} else if ( cpu_i > 70 and cpu_i <= 80 ) {

if ( deltapower < 100.0 )

lopower = deltapower * 0.43; hipower = deltapower *

0.78;

else
lopower = deltapower * 0.70; hipower = deltapower *

0.81;

} else if ( cpu_i > 80 ) {

if ( deltapower < 100.0 )

lopower = deltapower * 0.53; hipower = deltapower *

0.78;

else

lopower = deltapower * 0.74; hipower = deltapower *

0.83;

}

The system next performs a series of steps to approximate each point in a probability distribution with a set number of total points (step 1806). In some implementations, the probability distribution may have 200 total points. First, the system determines the adjustment factor for the CPU load specified in step 1800 based on the location of the given probability distribution point (step 1808). Next, the system calculates the CPU utilization and respective power draw (step 1810). Taking into account the fact that when CPU usage peaks, memory usage generally drops and power draw generally peaks (step 1812), the system then calculates memory usage and adjusts the calculated CPU utilization and power draw from step 1810 (step 1814). An example of code for these steps is as follows—

for i from 0 to 200 in increments of one unit

if ( i <= 40 ∥ i > 160 )

adjustcpu = 0.2;

else if ( i > 40 and i <= 80 )

adjustcpu = 0.5;

else if ( i > 80 and i <= 120 )

adjustcpu = 0.7;

else if ( i > 120 and i <= 160 )

adjustcpu = 0.4;

cpu = ( Math.random( ) * (cpuvar * adjustcpu) ) + cpu_i;
power = ( lopower + ( Math.random( ) * (hipower −

lopower) )) + idlepower;

if ( (i > 1 and i < 4) or (i > 30 and i < 40) or (i > 70 and i <

80) or (i > 110 and i < 120) or

(i > 150 and i < 160) or (i > 190 and i < 200) )

{

| | |
|---|---|
| cpu = cpuvar + cpu_i + (i/200); | // ‘max’, |

no random component

| | |
|---|---|
| mem = ( Math.random( ) * 10.0 ) + 15.0; | // drops to |

lowest

power = basepower + (basepower * powervar) +

idlepower + (i/200);

}

else {
mem = ( Math.random( ) * 20.0 ) + adjustmem;

if ( i == 15 or i == 30 or i == 45 or i == 105 or i ==

120 or i == 135 or i == 195 )

adjustmem += 15.0;

else if ( i == 60 or i == 75 or i == 90 or i == 150 or i

== 165 or i == 180 )

adjustmem −= 15.0;

}

Then, the system stores the calculated resource utilization (both CPU and memory) and the respective power draw into the training data file (step 1816). Finally, the process is repeated from step 1806-1816 for each point in the probability distribution, and the process is repeated from step 1802-1816 for each incremental CPU load to be calculated in accordance with step 1800 (step 1818).

The foregoing description of various embodiments provides illustration and description, but is not intended to be exhaustive or to limit the invention to the precise form disclosed. Modifications and variations are possible in light of the above teachings or may be acquired from practice in accordance with the present invention. It is to be understood that the invention is intended to cover various modifications and equivalent arrangements included within the spirit and scope of the appended claims.

What is claimed is:

1. A method in a data processing system for predicting future power consumption in computing systems, comprising:
receiving an indication of one or more computing devices to predict power for;
receiving one or more input parameters associated with the one or more computing devices;
automatically generating a prediction of the power consumption of the one or more computing devices over a future time interval; and
transmitting the generated prediction.

2. The method of claim 1, wherein further transmitting the generated prediction further comprises transmitting the generated prediction to one of: (1) user and (2) a computer system.

3. The method of claim 1, further comprising displaying the provided power prediction to a user.

4. The method of claim 1, further comprising generating the status of the current power consumption of the one or more computing devices.

5. The method of claim 4, further comprising transmitting the status of the current power consumption of the one or more computing devices.

6. The method of claim 1, wherein generating the prediction further comprises generating a prediction of future heat dissipation of the one of more computing devices.

7. The method of claim 1, wherein generating the prediction further comprises generating a prediction of future cooling costs of the one of more computing devices based on the prediction of future heat dissipation of the one or more computing devices.

8. The method of claim 1, wherein generating the prediction further comprises generating a prediction of future gas emission of the one of more computing devices.

9. The method of claim 1, wherein generating the prediction further comprises generating a prediction of future cost of the one of more computing devices.

10. The method of claim 1, wherein generating the prediction further comprises generating a prediction associated with a user.

11. The method of claim 1, wherein the one or more input parameters comprise one or more of: (1) a start date, (2) a time interval, (3) cost of power and (4) emission rates, (5) CPU utilization, and (6) memory utilization.

12. The method of claim 1, wherein the computing device comprises a virtual machine, and automatically generating comprises automatically generating a prediction of power consumption of the virtual machine.

13. The method of claim 1, further comprising automatically generating a prediction of future power consumption for one or more software applications on the one or more computing devices.

14. The method of claim 1, wherein the computing device is one of (1) server, (2) a storage drive, (3) a networking device, (4) an uninterruptible power supply (UPS), (5) a Power Distribution Unit (PDU), (6) a Computer Room Air Conditioner (CRAC), and (7) an HVAC device.

15. A data processing system for predicting future power consumption in computing systems, comprising:
a memory comprising instructions to cause a processor to:
receive an indication of one or more computing devices to predict power for;
receive one or more input parameters associated with the one or more computing devices;
automatically generate a prediction of the power consumption of the one or more computing devices over a future time interval; and
transmitting the generated prediction; and
the processor configured to execute the instructions in the memory.

16. The data processing system of claim 15, wherein transmitting the generated prediction further comprises transmitting the generated prediction to one of: (1) a user and (2) a computer system.

17. The data processing system of claim 15, wherein the instructions further cause the processor to display the provided power prediction to the user.

18. The data processing system of claim 15, wherein the instructions further cause the processor to generate the status of the current power consumption of the one or more computing devices.

19. The data processing system of claim 18, wherein the instructions further cause the processor to transmit the status of the current power consumption of the one or more computing devices.

20. The data processing system of claim 15, wherein generating the prediction further comprises generating a prediction of future heat dissipation of the one of more computing devices.

21. The data processing system of claim 15, wherein generating the prediction further comprises generating a prediction of future cooling costs of the one of more computing devices based on the prediction of future heat dissipation of the one or more computing devices.

22. The data processing system of claim 15, wherein generating the prediction further comprises generating a prediction of future gas emission of the one of more computing devices.

23. The data processing system of claim 15, wherein generating the prediction further comprises generating a prediction of future cost of the one of more computing devices.

24. The data processing system of claim 15, wherein the one or more input parameters comprise one or more of: (1) a start date, (2) a time interval, (3) cost of power and (4) emission rates, (5) CPU utilization, and (6) memory utilization.

25. The data processing system of claim 15, wherein the computing device comprises a virtual machine, and automatically generating comprises automatically generating a prediction of power consumption of the virtual machine.

26. The data processing system of claim 15, wherein the instructions further cause the processor to automatically generate a prediction of future power consumption for one or more software applications on the one or more computing devices.

27. The data processing system of claim 15, wherein generating the prediction further comprises generating a prediction associated with a user.

28. The data processing system of claim 15, wherein the computing device is one of: (1) server, (2) a storage drive, (3) a networking device, (4) an uninterruptible power supply (UPS), (5) a Power Distribution Unit (PDU), (6) a Computer Room Air Conditioner (CRAC), and (7) an HVAC device.

29. A method in a data processing system for determining current power consumption and predicting future power consumption in computing systems, comprising:
receiving an indication of one or more computing devices to predict power for;
receiving one or more input parameters associated with the one or more computing devices;
automatically generating one of: 1) a current status of the power consumption of the one or more computing devices, and 2) a prediction of the power consumption of the one or more computing devices over a future time interval; and
transmitting the one of: (1) the current status of the power consumption and (2) the generated prediction.

30. The method of claim 29, wherein transmitting the one of (1) the current status of the power consumption and (2) the generated prediction further comprises transmitting the generated prediction to one of: (1) a user and (2) a computer system.

31. The method of claim 29, further comprising displaying the provided power prediction to the user.

32. The method of claim 29, wherein automatically generating further comprises generating one of: (1) the current status of heat dissipation of one or more of the computing devices, and (2) generating a prediction of future heat dissipation of the one of more computing devices.

33. The method of claim 29, wherein automatically generating further comprises generating one of: (1) the current status of gas emission of one or more of the computing devices, and (2) generating a prediction of future gas emission of the one of more computing devices.

34. The method of claim 29, wherein automatically generating further comprises generating one of: (1) the current status of heat dissipation of one or more of the computing devices, and (2) generating a prediction of future heat dissipation of the one of more computing devices.

35. The method of claim 29, wherein automatically generating further comprises generating one of: (1) the current status of cost of one or more of the computing devices, and (2) generating a prediction of future cost of the one of more computing devices.

36. The method of claim 29, wherein generating the prediction further comprises generating a prediction of future gas emission of the one of more computing devices.
